(19) United States
(12) Patent Application Publication
(10) Pub. No.: US 2026/0303258 A1
(43) Pub. Date: Oct. 1, 2026

(54) TRANSMISSION OF SHAPING BITS WITHIN A SINGLE CODE BLOCK GROUP FOR BLOCK-CODE BASED CONSTELLATION SHAPING

(71) Applicant: QUALCOMM Incorporated, San Diego, CA (US)

(72) Inventors: Changlong XU, Beijing (CN); Liangming WU, Beijing (CN); Jing JIANG, San Diego, CA (US); Wei LIU, Beijing (CN); Yang QI, Beijing (CN)

(21) Appl. No.: 19/481,153

(22) PCT Filed: Jun. 24, 2023
(86) PCT No.: PCT/CN2023/102011

§ 371 Date: Nov. 3, 2025

(51) Int. Cl. H04L 1/00; H04L 1/1829

(52) U.S. Cl. CPC H04L 1/0057; H04L 1/0042; H04L 1/1864

(57) ABSTRACT

Apparatuses and methods for transmission of shaping bits within a CBG for block-code based constellation shaping are described. An apparatus generates shaping bits, from information bits, in a CBG having multiple CBs, and generates encoded shaping bits for at least one of the multiple CBs by encoding the shaping bits using shaping encoding. The apparatus transmits, to a receiver node, the CBG including CBs with encoded information bits based on the shaping bits, unencoded information bits, and a CB including the encoded shaping bits. Another apparatus receives a CBG including CBs having unencoded information bits, encoded shaping bits, and encoded information bits encoded based on the encoded shaping bits and that represent transmitter node information. The apparatus generates decoded information bits and decoded shaping bits by jointly decoding the encoded information and encoded shaping bits. The apparatus estimates the information bits by encoding the decoded information and decoded shaping bits.

### TECHNICAL FIELD

The present disclosure relates generally to communication systems, and more particularly, to wireless communications utilizing code blocks and shaping.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to generate shaping bits based on information bits for transmission in a code block group (CBG), where the CBG is comprised of multiple code blocks (CBs). The apparatus is also configured to generate encoded shaping bits for at least one of the multiple CBs by encoding the shaping bits using a shaping encoder. The apparatus is also configured to transmit, to a receiver node, the CBG including a first set of one or more CBs comprising encoded information bits that are encoded based on the shaping bits, unencoded information bits, and a second set of one or more CBs including the encoded shaping bits.

In the aspect, the method includes generating shaping bits based on information bits for transmission in a CBG, where the CBG is comprised of multiple CBs. The method also includes generating encoded shaping bits for at least one of the multiple CBs by encoding the shaping bits using a shaping encoder. The method also includes transmitting, to a receiver node, the CBG including a first set of one or more CBs comprising encoded information bits that are encoded based on the shaping bits, unencoded information bits, and a second set of one or more CBs including the encoded shaping bits.

In another aspect of the disclosure, a method, a computer-readable medium, and an apparatus are provided. The apparatus is configured to receive a CBG including a set of one or more CBs, the set of one or more CBs comprising unencoded information bits, encoded shaping bits, and encoded information bits that are encoded based on the encoded shaping bits and that represent information bits of a transmitter node. The apparatus is also configured to generate decoded information bits and decoded shaping bits by jointly decoding the encoded information bits and the encoded shaping bits. The apparatus is also configured to estimate the information bits by encoding the decoded information bits and the decoded shaping bits.

In the aspect, the method includes receiving, a CBG including a set of one or more CBs, the set of one or more CBs comprising unencoded information bits, encoded shaping bits, and encoded information bits that are encoded based on the encoded shaping bits and that represent information bits of a transmitter node. The method also includes generating decoded information bits and decoded shaping bits by jointly decoding the encoded information bits and the encoded shaping bits. The method also includes estimating the information bits by encoding the decoded information bits and the decoded shaping bits.

In another aspect of the disclosure, an apparatus is provided for wireless communication at a transmitter node. The apparatus includes at least one memory and at least one processor coupled to the at least one memory. The at least one processor, individually or in any combination, is configured to cause the apparatus to: generate shaping bits based on information bits for transmission in a CBG, where the CBG is comprised of multiple CBs; generate encoded shaping bits for at least one of the multiple CBs by encoding the shaping bits using a shaping encoder; and transmit, to a receiver node, the CBG including a first set of one or more CBs comprising encoded information bits that are encoded based on the shaping bits, unencoded information bits, and a second set of one or more CBs including the encoded shaping bits.

In another aspect of the disclosure, an apparatus is provided for wireless communication at a receiver node. The apparatus includes at least one memory and at least one processor coupled to the at least one memory. The at least one processor, individually or in any combination, is configured to cause the apparatus to receive a CBG including a set of one or more CBs, the set of one or more CBs comprising unencoded information bits, encoded shaping bits, and encoded information bits that are encoded based on the encoded shaping bits and that represent information bits of a transmitter node; generate decoded information bits and decoded shaping bits by jointly decoding the encoded information bits and the encoded shaping bits; and estimate the information bits by encoding the decoded information bits and the decoded shaping bits.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example bit masking and CBG transmission configurations.

FIG. 5 is a diagram illustrating example block code transmitter (Tx) and receiver (Rx) configurations.

FIG. 6 is a diagram illustrating an example block code based shaping Tx configuration.

FIG. 7 is a call flow diagram for wireless communications, in accordance with various aspects of the present disclosure.

FIG. 8 is a diagram illustrating an example block code based constellation shaping Tx configuration, in accordance with various aspects of the present disclosure.

FIG. 9 is a diagram illustrating example configurations for shaping bit transmissions and for block code based constellation shaping of shaping bit CBs, in accordance with various aspects of the present disclosure.

FIG. 10 is a diagram illustrating examples of decoding acknowledgement/negative acknowledgement, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

Wireless communication networks may enable wireless devices to transmit and receive data using CBs. A wireless device may include a transmitter that uses a block decoder and a shaping encoder to mask information bits and to jointly encode the shaped information bits and the shaping bits. A receiving device may then receive the encoded data, jointly decode the shaped information bits and the shaping bits, and determine the original information bits of the data. This data may be transmitted as transport blocks (TBs), and such TBs may be segmented into CBs. The CBs may be grouped in CBGs to facilitate transmission sizes, retransmissions, and/or the like, for the data in the TBs. Shaping encoders may allow a transmitter to generate a mask sequence using log-likelihood ratios (LLRs) for a block decoder, computed as a power reduction after performing bit masking, and using the shaping bits as the decoder output. For example, the LLRs may be generated according to how much power is saved by changing a bit. In the context of block code-based constellation shaping, an information bit sequence may be divided in subsequences of a given length as inputs to a shaping encoder that uses associated block codes.

However, the number of sign bit positions available for such block code-based constellation shaping may be insufficient for the total number of parity bits and shaping bits used. That is, for a given shaping rate of a shaping encoder and a given coding rate for a forward error correction (FEC) encoder, the total number of parity bits and shaping bits may exceed the number of sign bit positions available. As shaping rate may be a tuning parameter for block-code based shaping, the above may potentially restrict some choices of the shaping rate from being utilized, and consequently the performance of the allowable shaping may be diminished.

Various aspects relate generally to wireless communications utilizing code blocks and shaping that overcome such restrictions and improve performance by enabling a greater range of shaping rates. Some aspects more specifically relate to transmission of shaping bits within a single code block group for block-code based constellation shaping. In one example, a transmitter node may generate shaping bits based on information bits for transmission in a CBG, where the CBG is comprised of multiple CBs. The transmitter node may also generate encoded shaping bits for at least one of the multiple CBs by encoding the shaping bits using a shaping encoder. The transmitter node may also transmit, to a receiver node, the CBG including a first set of one or more CBs comprising encoded information bits that are encoded based on the shaping bits, unencoded information bits, and a second set of one or more CBs including the encoded shaping bits. The transmitter node may generate the encoded information bits for at least another of the multiple CBs by encoding a portion of the information bits for the CBG using the shaping bits. The transmitter node may receive, from the receiver node and based on the transmitted CBG, at least one of: a hybrid automatic repeat request (HARQ) acknowledgement (HARQ-ACK) for the transmitted CBG that indicates a successful decode for both of the first set of one or more CBs, the first set of one or more CBs comprising the encoded information bits that are encoded based on the shaping bits, and the unencoded information bits, or a HARQ negative acknowledgement (HARQ-NACK) for the transmitted CBG that indicates an unsuccessful decode for at least one CB of the first set of one or more CBs, the first set of one or more CBs comprising the encoded information bits that are encoded based on the shaping bits, or the unencoded information bits. The transmitter node may receive, from the receiver node and based on the transmitted CBG, at least one of: a HARQ-ACK for the transmitted CBG, where the HARQ-ACK indicates a successful decode of each CB of the transmitted CBG, or a HARQ-NACK for the transmitted CBG, where the HARQ-NACK indicates an unsuccessful decode for at least one CB of the transmitted CBG. In another example, a receiver node may receive a CBG including a set of one or more CBs, the set of one or more CBs comprising unencoded information bits, encoded shaping bits, and encoded information bits that are encoded based on the encoded shaping bits and that represent information bits of a transmitter node. The receiver node may also generate decoded information bits and decoded shaping bits by jointly decoding the encoded information bits and the encoded shaping bits. The receiver node may also estimate the information bits by encoding the decoded information bits and the decoded shaping bits. The receiver node may transmit, for the transmitter node and based on the received CBG, at least one of: a HARQ-ACK for the received CBG, where the HARQ-ACK indicates a successful decode for both of the set of one or more CBs, or a HARQ-NACK for the received CBG, where the HARQ-NACK indicates an unsuccessful decode for at least one CB of the set of one or more CBs. The receiver node may transmit, for the transmitter node and based on the received CBG, at least one of: a HARQ-ACK for the received CBG, where the HARQ-ACK indicates a successful decode for each CB of the received CBG, or a HARQ-NACK for the received CBG, where the HARQ-NACK indicates an unsuccessful decode for at least one CB of the received CBG.

Particular aspects of the subject matter described in this disclosure can be implemented to realize one or more of the following potential advantages. In one example, the described techniques can be used to allow a greater range of shaping rates and improve shaping performance by transmitting shaping bits for a CBG in one or more specific CBs within the CBG from which the shaping bits are generated. In another example, the described techniques can be used to improve Rx latency and Tx encoding efficiency/performance by transmitting a shaping bit-specific CB at the beginning of the CBG or at the end of the CBG. In an additional example, the described techniques can be used to improve encoding block performance by applying block-code based constellation shaping to the shaping bit-specific CB that carries the shaping bits of the CBG.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

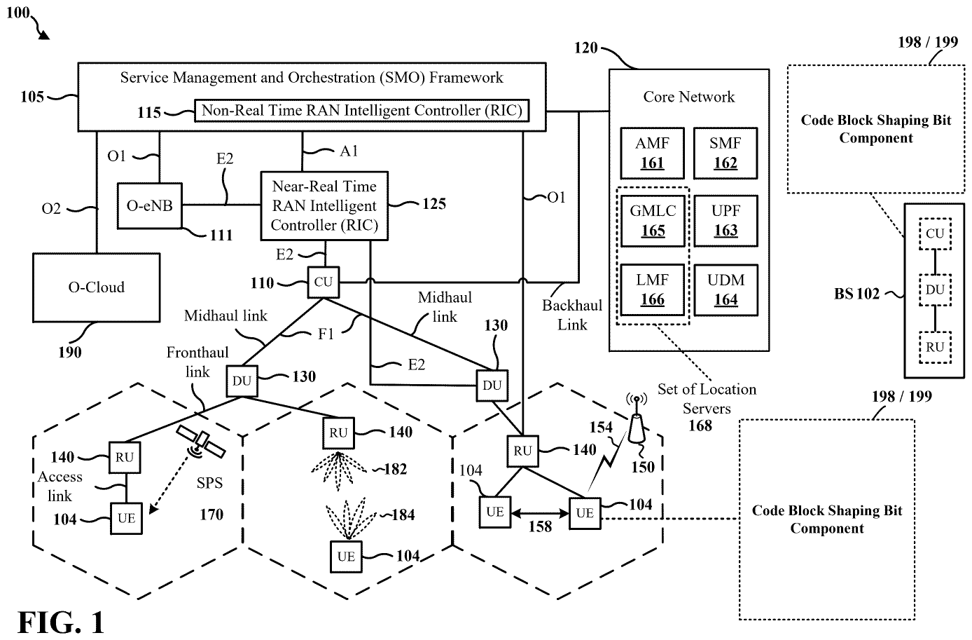

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 and/or the base station 102 may have a code block shaping bit component 198 (“component 198”) that may be configured to generate shaping bits based on information bits for transmission in a CBG, where the CBG is comprised of multiple CBs. The component 198 may be configured to generate encoded shaping bits for at least one of the multiple CBs by encoding the shaping bits using a shaping encoder. The component 198 may be configured to transmit, to a receiver node, the CBG including a first set of one or more CBs comprising encoded information bits that are encoded based on the shaping bits, unencoded information bits, and a second set of one or more CBs including the encoded shaping bits. The component 198 may be configured to generate the encoded information bits for at least another of the multiple CBs by encoding a portion of the information bits for the CBG using the shaping bits. The component 198 may be configured to receive, from the receiver node and based on the transmitted CBG, at least one of: a HARQ-ACK for the transmitted CBG that indicates a successful decode for both of the first set of one or more CBs, the first set of one or more CBs comprising the encoded information bits that are encoded based on the shaping bits, and the unencoded information bits, or a HARQ-NACK for the transmitted CBG that indicates an unsuccessful decode for at least one CB of the first set of one or more CBs, the first set of one or more CBs comprising the encoded information bits that are encoded based on the shaping bits, or the unencoded information bits. The component 198 may be configured to receive, from the receiver node and based on the transmitted CBG, at least one of: a HARQ-ACK for the transmitted CBG, where the HARQ-ACK indicates a successful decode of each CB of the transmitted CBG, or a HARQ-NACK for the transmitted CBG, where the HARQ-NACK indicates an unsuccessful decode for at least one CB of the transmitted CBG. In certain aspects, the UE 104 and/or the base station 102 may have a code block shaping bit component 199 (“component 199”) that may be configured to receive a CBG including a set of one or more CBs, the set of one or more CBs comprising unencoded information bits, encoded shaping bits, and encoded information bits that are encoded based on the encoded shaping bits and that represent information bits of a transmitter node. The component 199 may be configured to generate decoded information bits and decoded shaping bits by jointly decoding the encoded information bits and the encoded shaping bits. The component 199 may be configured to estimate the information bits by encoding the decoded information bits and the decoded shaping bits. The component 199 may be configured to transmit, for the transmitter node and based on the received CBG, at least one of: a HARQ-ACK for the received CBG, where the HARQ-ACK indicates a successful decode for both of the set of one or more CBs, or a HARQ-NACK for the received CBG, where the HARQ-NACK indicates an unsuccessful decode for at least one CB of the set of one or more CBs. The component 199 may be configured to transmit, for the transmitter node and based on the received CBG, at least one of: a HARQ-ACK for the received CBG, where the HARQ-ACK indicates a successful decode for each CB of the received CBG, or a HARQ-NACK for the received CBG, where the HARQ-NACK indicates an unsuccessful decode for at least one CB of the received CBG. Accordingly, the aspects herein for transmission of shaping bits within a CBG for block-code based constellation shaping may allow a greater range of shaping rates and improve shaping performance, may improve Rx latency and Tx encoding efficiency/performance, and may improve encoding block performance.

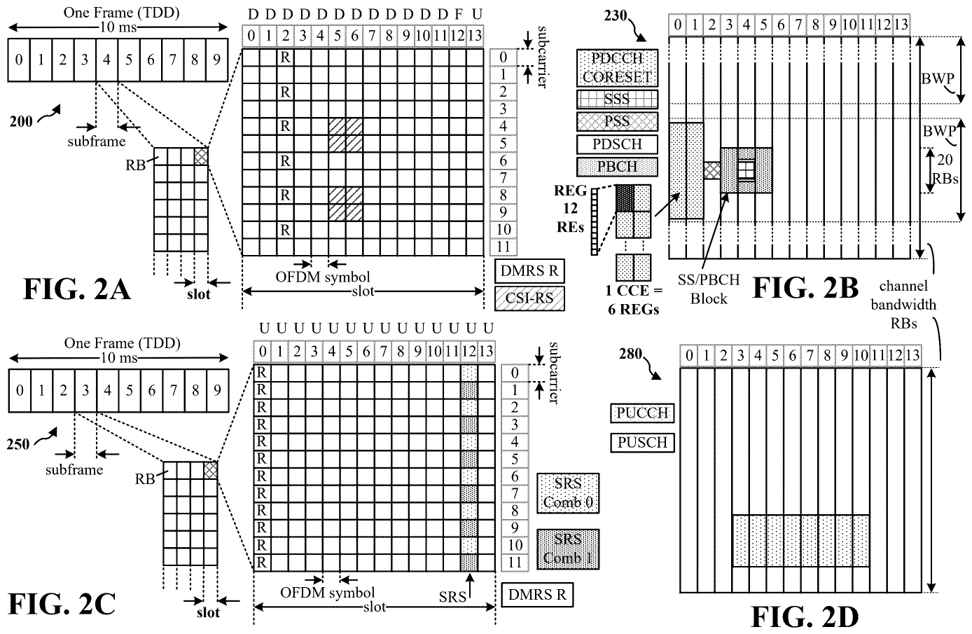

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

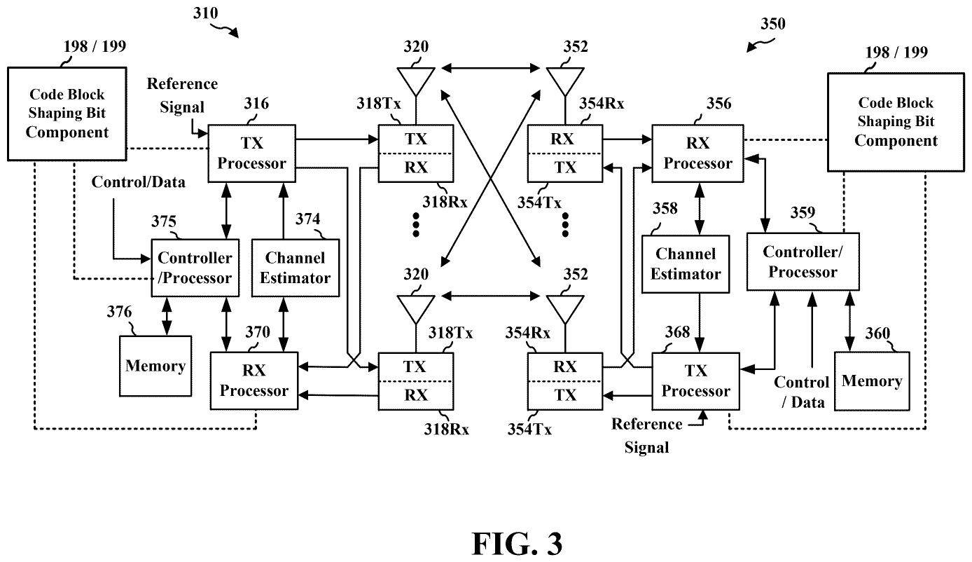

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

Wireless devices in wireless communication networks may transmit and receive data using CBs. A wireless device may include a transmitter that uses a block decoder and a shaping encoder to mask information bits and to jointly encode the shaped information bits and the shaping bits. A receiver (e.g., a second wireless device) may then receive the encoded data, jointly decode the shaped information bits and the shaping bits, and determine the original information bits of the data. This data may be transmitted as TBs, and such TBs may be segmented into CBs. The CBs may be grouped in CBGs to facilitate transmission sizes, retransmissions, and/or the like, for the TBs and data. Shaping encoders may allow a Tx to generate a mask sequence using log-likelihood ratios LLRs for a block decoder, computed as a power reduction after performing bit masking, and using the shaping bits as the decoder output. In the context of block code-based constellation shaping, an information bit sequence may be divided in subsequences of a given length as inputs to a shaping encoder that uses associated block codes. However, the number of sign bit positions available for such block code-based constellation shaping may be less than the total number of parity bits and shaping bits to be communicated. That is, for a given shaping rate of a shaping encoder and a given coding rate for a FEC encoder, the total number of parity bits and shaping bits may exceed the number of available sign bit positions. The shaping rate may be a variable (e.g., tunable) parameter for block-code based shaping, and some choices of the shaping rate may not be utilized if the number of parity bits and shaping bits would exceed the number of available sign bit positions. Consequently, the performance of the shaping may be diminished by the reduced shaping options.

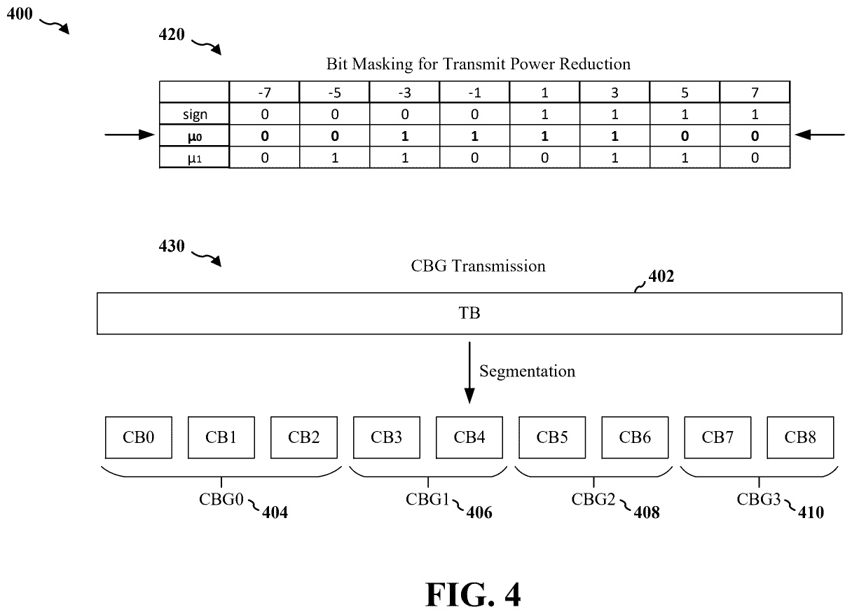

FIG. 4 is a diagram 400 illustrating example bit masking and CBG transmission configurations. Diagram 400 shows a table 420 illustrating aspects of bit masking for transmit power reduction and a configuration 430 for CBG transmission.

When transmitting an encoded signal, the transmit power may be related to the bit-level of the transmitted symbol. There is a relationship between bit-level and symbol transmit power, for example, a second bit (e.g., a most significant bit (MSB)) or a third bit (e.g., a least significant bit (LSB)) may be more determinative of a transmit power than a sign bit for a symbol “s”. The table 420 shows example bit-levels of transmitted symbols. For instance, and as illustrated, the most significant bit (MSB) other than the sign, e.g., u₀, may have more effect on the symbol transmit power, assuming binary reflected Gray code (BRGC) or Gray mapping. The bit-0 (e.g., u₀ or a) may have more of an effect on the transmit power than other bits (e.g., sign bit or u₁ bit). The transmit power of the symbols with bit-0 of ‘0’ may be lower than that of the transmitted symbols with bit-0 of ‘1’. For example, the power associated with a symbol “s” may be related to a square of an amplitude of the symbol such that switching a bit μ₀ from a “1” to a “0” may lower a transmit power (from ‘49 to ‘1’ or from ‘25’ to ‘9’) and switching a bit μ₁ from a “1” to a “0” may lower a transmit power (from ‘49 to ‘25’ or from ‘9’ to ‘1’).

The transmitted bit sequence may be adjusted to lower the transmit power. For example, a bit-mask may be applied on the MSB to reduce the power. That is, a mask sequence v may be applied on the MSB u₀ to obtain a masked bit \tilde{μ}₀=u₀ ⊕v to lower the transmit power.

As presented herein, bit masking for transmit power reduction, implementations may use a bit-masking sequence on the MSBs other than the sign. For example, in a transmitter for a sequence of information bits, considering a first bit u₀ of the sequence and a masking sequence v, an encoded bit c₀ that corresponds to u₀ may be represented as c₀=u₀+v. Other examples of shaping include “trellis shaping” or “concatenated shaping.”

In the configuration 430 for CBG transmission, CBG-based transmission for channels such as PDSCH and/or PUSCH with a low-density parity-check (LDPC) encoder may include a TB 402 including a plurality of code blocks that are segmented into a multiple CBGs. In order to illustrate the concept of multiple CBGs in a TB, FIG. 4 illustrates, by way of example and not limitation, a CBG0 404, a CBG1 406, a CBG2 408, and a CBG3 410, although more or fewer CBGs are contemplated for different implementations. In the illustrated example, the CBG0 404 includes three CBs (CB0, CB1, CB2), the CBG1 406 includes two CBs (CB3, CB4), the CBG2 408 includes two CBs (CB5, CB6), and the CBG3 410 includes two CBs (CB7, CB8), although more or fewer CBs are contemplated for different CBG implementations. In various implementations, there may be a maximum number of CBGs per TB. As an example, a maximum configurable number of CBGs per TB may be 8. Examples of maximum number of CBGs per TB may be 2, 4, 6, or 8, e.g., equal to or less than the maximum configurable number of CBGs. Additionally, retransmissions may be performed for individual CBGs rather than for a retransmission of the TB. In some aspects, the retransmission of individual CBGs may be referred to as per CBG retransmission, CBG-wise, retransmission, CBG level retransmission, or CBG based retransmission, e.g., rather than TB-wise, per TB, TB level, or TB based retransmission. That is, retransmissions may be performed for individual CBGs (e.g., one or more CBGs that are not accurately received) rather than retransmitting an entire TB that may include a subset of CBGs that were successfully received by the receiver. Aspects presented herein provide for block code based constellation shaping.

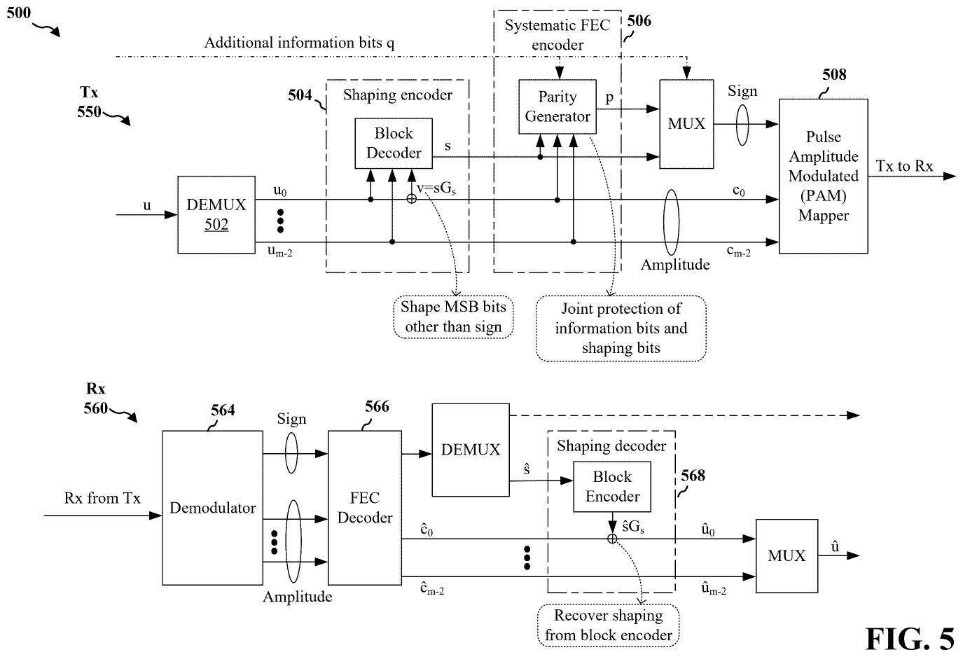

FIG. 5 is a diagram 500 illustrating example block code transmitter (Tx) and receiver (Rx) configurations. Diagram 500 shows a configuration for a transmitter 550 and a configuration for an associated receiver 560.

The transmitter 550 may utilize a block decoder as a shaping encoder to “mask” the information bits from a demultiplexer 502. The transmitter may then jointly encode the shaped information bits c and the shaping bits s obtained from a shaping encoder 504 using an FEC encoder 506. A mapper 508 may map the shaped bits to symbols that are transmitted in a wireless signal to the receiver 560. The LLR inputs to the block decoder may be computed as the potential power reduction after performing the information bit masking. The receiver 560 may jointly decode shaped information bits and shaping bits § at FEC decoder 566 after demodulation at demodulator 564. The receiver 560 may then reencode these bits at a block encoder of a shaping decoder 568 to estimate the original information bits (e.g., originating as from the perspective of the transmitter 550).

Code-based shapers, such as the transmitter 550 and the receiver 560, may provide for lower complexity and latency, e.g., addition/multiplication operations may be typically or mostly utilized thereby, and such receiver designs may include little complexity.

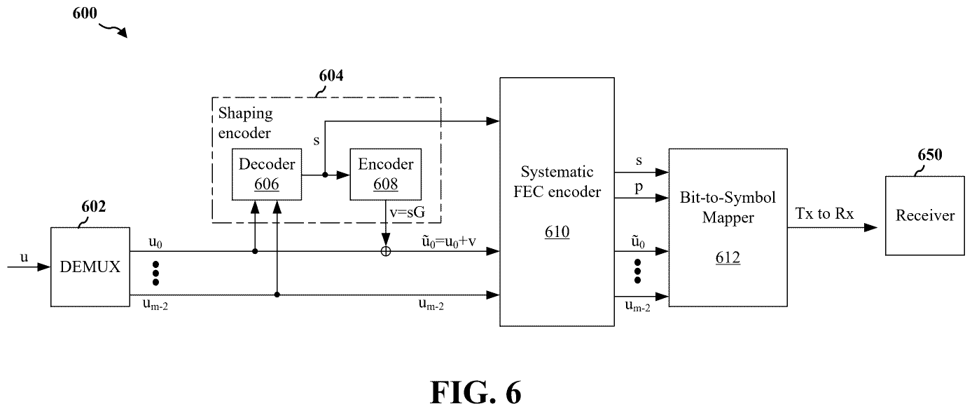

FIG. 6 is a diagram 600 illustrating an example block code based shaping transmitter configuration. Diagram 600 shows the transmitter side configuration of a block code based shaper. As illustrated, the transmitter may include a shaping encoder 604 to generate a mask sequence v, where the LLRs input to the block decoder are computed as the power reduction after performing bit masking. In some aspects, the LLRs may be generated according to how much power is saved by bit flipping (e.g., changing or switching a bit, such as by using masking described above with respect to table 420 in FIG. 4). The shaping bits s are illustrated as the decoder output from the decoder 606 that are provided to the encoder 608 that outputs a shaping bit mask. The mask sequence, v=sG, may mask a portion of sequence of information bits, where G is a shaping parameter or generator matrix. As shown in FIG. 6, a bit masking process may be applied on the input information, e.g., from the demultiplexer 602. For example, the first bit of the input information may change from u₀ to ũ₀=u₀ ⊕v after the bit masking process, where v is a shaping codeword or mask sequence. The FEC encoder 610 may jointly encode the shaped information bits and the shaping bits, as shown. For example, the input information, after the bit masking is applied, may be provided to an encoder along with the shaping bits. The information bits (ũ₀, . . . , uₘ₋₂), the parity bits (p), and the shaping bits(s) may then be mapped to modulation symbols for transmission to a corresponding receiver. The encoded input information may be converted to symbols by, for example, a bit-to-symbol mapper 612, and then transmitted through a wireless channel to a receiver 650. Upon receiving the transmitted symbols, the receiver 650 may recover the information bits with a simplified channel decoder. For example, the receiver 650 may include a converter to return the received symbol to bits, e.g., based on an LLR. The bits may then be provided to an FEC decoder that generates a set of shaping bits and shaped information from the converted bits, e.g., as described in connection with the receiver in FIG. 5.

Probability Amplitude Shaping (PAS) is a coded modulation strategy that adjusts the symbol distribution. PAS may include a distribution matcher that maps a bit sequence, in which each bit in the bit sequence has the same probability of being 1 or 0, to a symbol sequence, in which the symbols in the symbol sequence have the desired distribution (e.g., a Maxwell-Boltzmann distribution approximates a Gaussian distribution). Each of the symbol sequences may have the same length (i.e., the symbol block length). An example bit-to-symbol mapping of the PAS that maps a bit sequence to a symbol sequence. The mapping relationship between the bit sequences and the symbol sequences may be chosen so that the symbols used in the transmission have a desired symbol distribution, such as a Gaussian or near Gaussian distribution.

In the context of the above description, an information bit sequence u may demultiplexed into portions u₀, u₁, . . . , uₘ₋₂, each having length Nₐ. Nₐ is the modulation symbol length, and {1, 3, . . . , 2^{m}−1} is the set of amplitude symbols. A shaping encoder may use an (N,K) block code with N<Nₐ, and each of u₀, u₁, . . . , uₘ₋₂ may be segmented into κ=[Nₐ/N] segments with a total of (m−1)Nₐ information bits, and the shaping bits and the parity bits may be typically mapped to sign bits within a single code block. However, Nₐ sign bit positions may be less than a combination of the parity bits and the shaping bits.

For instance, if Rₛ is the shaping rate of the shaping encoder, and R_{c} is the coding rate of the FEC encoder, in this example, if Rₛ>1−m(1−R_{c}), then the total number of the parity bits and the shaping bits exceeds Nₐ. As shaping rate may be a tuning parameter for block-code based shaping, the use of the sign bits to provide shaping information can limit some choices of the shaping rate Rₛ and consequently the performance of the shaped transmission.

The described aspects consider block code-based constellation shaping within a single CBG, as well as block code-based constellation shaping within multiple CBGs. A transmitter utilizes a block decoder and encoder, e.g., which may be taken together/collectively as a shaping encoder, to mask the information bits, and jointly encodes the shaped information bits and shaping bits by an FEC encoder. The aspects presented herein overcome a limitation in a number of shaping bits associated with use of the sign bit positions to carry both the parity bits and the shaping bits. The aspects presented herein provide several techniques for shaping bits transmission that enables a greater choice in shaping rate for the transmission, and thereby enables more accurate communication. For example, the shaping bits for a CBG may be transmitted in one or more particular CBs within the CBG for which the shaping bits are generated. The inclusion of the shaping bits in CBs of a CBG helps to enable CBG level retransmission.

Various aspects herein for transmission of shaping bits within a single CBG for block-code based constellation shaping, as well as block code-based constellation shaping within multiple CBGs, may allow a greater range of shaping rates and improve shaping performance by transmitting shaping bits for a CBG in one or more CBs within the CBG from which the shaping bits are generated, By enabling a greater range of shaping rates, the inclusion of the shaping bits in a CB of the CBG enables improvements in Rx latency and Tx encoding efficiency/performance. For example, by transmitting a CB carrying the shaping bits at the beginning of the CBG or at the end of the CBG, the shaping bit information may improve encoding block performance by applying block-code based constellation shaping to the shaping bit-specific CB that carries the shaping bits of the CBG.

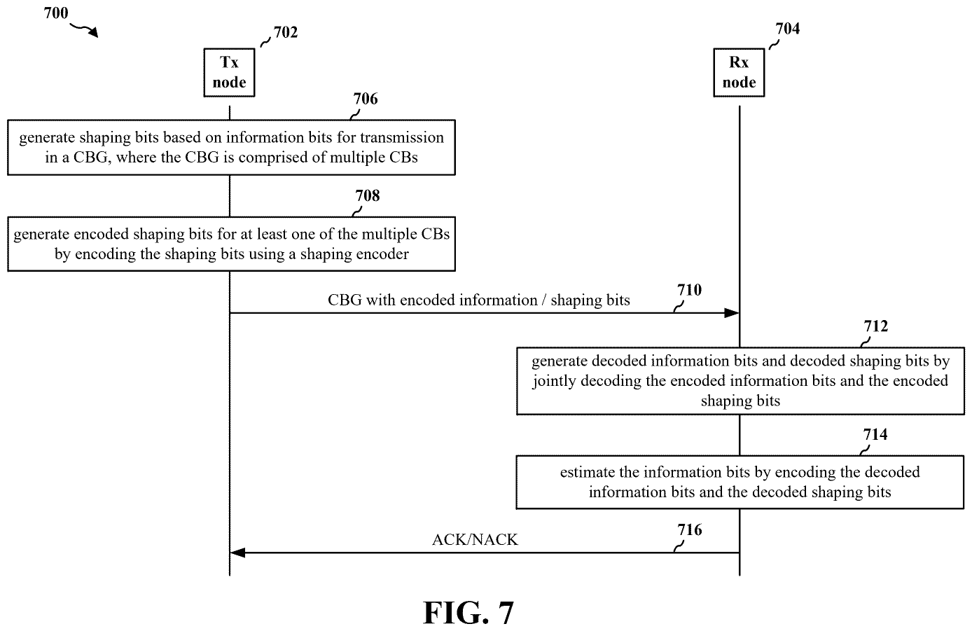

FIG. 7 is a call flow diagram 700 for wireless communications, in various aspects. Call flow diagram 700 illustrates transmission of shaping bits within a CBG for block-code based constellation shaping by a Tx node (e.g., a Tx node 702) that may communicate with a Rx node (e.g., a Rx node 704). In aspects, a UE and/or a network node (e.g., a base station, such as a gNB or other type of base station, by way of example) may include the Tx node 702 and/or the Rx node 704 for wireless communications using shaping bits within a CBG for block-code based constellation shaping. Aspects described for the Tx node 702 and/or the Rx node 704 in the context of a base station may be performed by the base station in aggregated form and/or by one or more components of the base station in disaggregated form.

In the illustrated aspect, the Tx node 702 may be configured to generate (at 706) shaping bits based on information bits for transmission in a CBG 710. In aspects, the CBG 710 may include multiple CBs, as described herein, e.g., a first set of CBs and a second set of CBs. The first set of CBs for the CBG 710 may include encoded information bits that are encoded based on the shaping bits, and the second set of CBs (e.g., one or more CBs) may include encoded shaping bits. A CB with shaping bits may be a different size than CBs with data. That is, according to aspects herein, a CBG may include a specific CB for transmission of the encoded shaping bits. CBs of the CBG 710 may also include unencoded information bits. The Tx node 702 may be configured to generate (at 706) the shaping bits using a decoder of a shaping encoder that decodes the information bits.

The Tx node 702 may be configured to generate (at 708) encoded shaping bits for at least one of the multiple CBs by encoding the shaping bits using the shaping encoder. In some aspects, the shaping encoder may be configured to generate (at 708) the encoded shaping bits, which may be included in a specific CB, by encoding using block code-based constellation shaping. That is, the shaping bits may be configured to alter a distribution, e.g., by masking the information bits, of at least one symbol in the CBG for the block code-based constellation shaping. In other aspects, the FEC encoder may be configured to generate (at 708) the encoded shaping bits, which may be included in a specific CB, by encoding using a coding scheme that is different from block code-based constellation shaping, e.g., using FEC. The Tx node 702 may also be configured to generate encoded information bits for another of the multiple CBs by encoding a portion of the information bits for the CBG using the shaping bits. In aspects, at least one of encoding the shaping bits (e.g., at 706) or encoding the portion of the information bits for the CBG using the shaping bits may include encoding based on an FEC encoder(s).

The Tx node 702 may be configured to encode the shaping bits, e.g., using the shaping encoder, by generating additional shaping bits based on the shaping bits of other CBs and encoding the shaping bits and the additional shaping bits using block code-based constellation shaping. For example, the shaping bits encoded by the shaping encoder may be further shaped themselves. In this way, additional shaping bits for the CB having the encoded shaping bits may be used to further shape the CBG and improve performance with block code based constellation shaping of the CB with the shaping bits.

In aspects, to generate (at 708) the encoded shaping bits by encoding the shaping bits using the shaping encoder, the Tx node 702 may be configured to generate at least one parity bit for the CBG based on encoding the shaping bits, e.g., using the FEC encoder, and may be configured to map the at least one parity bit, the shaping bits, and the additional shaping bits to sign bits of the CBG and to map at least one information bit of the at least one of the multiple CBs to at least one non-sign bit of the CBG, respectively, e.g., using a bit-to-symbol mapper. Regarding the mapping by the Tx node 702 of the at least one information bit of the at least one of the multiple CBs to at least one non-sign bit of the CBG, respectively, the Tx node 702 may be configured to map a specific information bit to a specific non-sign bit of the CBG, and may be configured to perform such mapping for each information bit to a corresponding (e.g., different) non-sign bit.

The Tx node 702 may be configured to transmit, to the receiver node 704 which may be configured to receive, the CBG 710. As noted, the CBG 710 may include a first set of one or more CBs that having the encoded information bits that are encoded based on the shaping bits, the CBG 710 may include the unencoded information bits, and the CBG 710 may include the second set of one or more CBs including the encoded shaping bits. In aspects, the one(s) of the multiple CBs that includes the encoded shaping bits may include a first CB of the multiple CBs that is transmitted, or may include a final CB of the multiple CBs that is transmitted. For instance, a CB with the encoded shaping bits may be transmitted as the first of the CBs in the CBG, or may be transmitted as a last of the CBs, or final CB, in the CBG.

Subsequent to receiving the CBG 710 from the Tx node 702, the Rx node 704 may be configured to generate (at 712) decoded information bits and decoded shaping bits by jointly decoding the encoded information bits and the encoded shaping bits. In aspects, the Rx node 704 may be configured to jointly decoding the encoded information bits and the encoded shaping bits for the CBG by decoding at least one FEC encoding. As noted above, the encoded shaping bits that is Rx node 704 is configured to decode (e.g., at 712) may include additional encoded shaping bits, such as additional shaping bits specifically for the CB that includes the shaping bits, which may be associated with block code-based constellation shaping for the encoded shaping bits. In such aspects, jointly decoding the encoded information bits and the encoded shaping bits by the Rx node 704 may include decoding the additional encoded shaping bits. In aspects, the Rx node 704 may be configured to jointly decode the encoded information bits and the encoded shaping bits by decoding a first mapping of at least one parity bit, the encoded shaping bits, and the additional encoded shaping bits from sign bits of the CBG, and decoding a second mapping of at least one information bit from at least one non-sign bit of the CBG, respectively (e.g., decoding the bitwise mapping of each information bit with each corresponding non-sign bit).

The Rx node 704 may be configured to estimate (at 714) the information bits by encoding the decoded information bits and the decoded shaping bits. For example, the Rx node 704 may reencode the decoded information bits and/or the decoded shaping bits in order to estimate (at 714) the original information bits. The Rx node 704 may also notify the Tx node 702 as to whether the CBG 710 was properly decoded. For instance, the Rx node 704 may be configured to transmit, and the Tx node 702 may be configured to receive, an ACK/NACK 716 that is associated with the decoding of the CBG 710. In aspects, the ACK/NACK 716 may be a HARQ-ACK or a HARQ-NACK.

In one example, for a first ACK/NACK configuration, the Rx node 704 may be configured to transmit, and the Tx node 702 may be configured to receive, as the ACK/NACK 716, a HARQ-ACK for the CBG 710 (e.g., that indicates a successful decode for at least one CB of the first set of one or more CBs, the first set of one or more CBs comprising the encoded information bits that are encoded based on the shaping bits, or the unencoded information bits), or a HARQ-NACK for the received CBG (e.g., where the HARQ-NACK indicates an unsuccessful decode for at least one CB of the set of one or more CBs). In another example, for a second ACK/NACK configuration, the Rx node 704 may be configured to transmit, and the Tx node 702 may be configured to receive, as the ACK/NACK 716, a HARQ-ACK for the transmitted CBG (e.g., where the HARQ-ACK indicates a successful decode of each CB of the transmitted CBG), or a HARQ-NACK for the transmitted CBG (e.g., where the HARQ-NACK indicates an unsuccessful decode for at least one CB of the transmitted CBG).

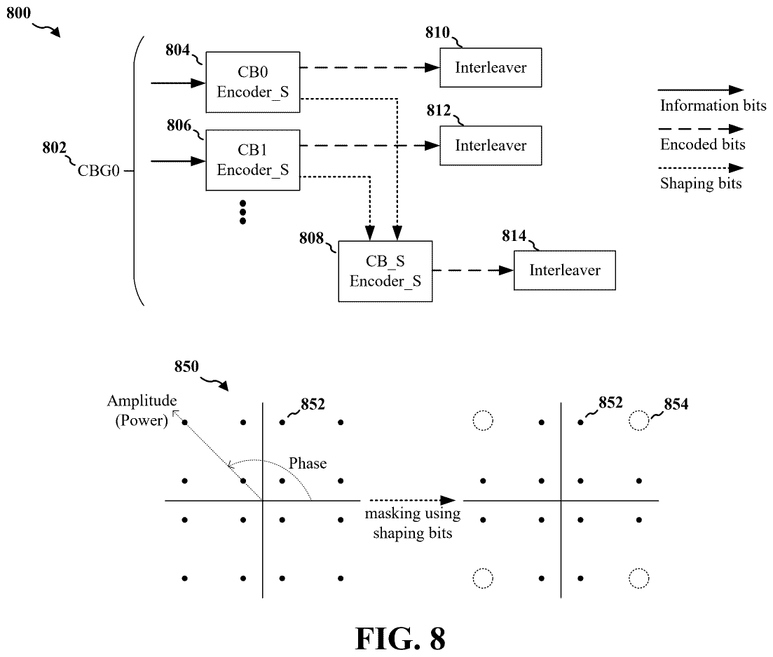

FIG. 8 is a diagram 800 illustrating an example block code based constellation shaping Tx configuration, in various aspects. As shown, a CBG 802 (“CBG0”) may include multiple CBs. The multiple CBs may include a first set of CBs for information bits (e.g., encoded or not) and a second set of CBs (e.g., one or more) for shaping bits. The CBG 802 may have ones of its information bits for CBs processed by associated encoders, e.g., an encoder 804 for a first CB (CB0), an encoder 806 for a second CB (CB1), etc. The encoder 804 and the encoder 806 may respectively output encoded bits of information and shaping bits for the first CB and the second CB.

As described herein, the shaping bits for a CBG may be transmitted in one or more special CBs within the CBG from which the shaping bits are generated. A shaping encoder 808 (of a CB noted as the “CB_S” block) carrying the shaping bits within the CBG 802 may be an encoder that utilizes block code based constellation shaping. The shaping bits of the encoder 804 and the encoder 806 may be provided to the shaping encoder 808, and the shaping encoder 808 may output its encoded bits. The encoded bits output by the encoder 804 may be provided to an interleaver 810, the encoded bits output by the encoder 806 may be provided to an interleaver 812, and the encoded bits output by the shaping encoder 808 may be provided to an interleaver 814, for further processing and transmission of the CBG 802 to an Rx, as described herein. Accordingly, the shaping bits of the CBG 802 may be included in one CB.

Diagram 800 also illustrates an example of a masking configuration 850 for block code based constellation shaping. Shaping bits may be masked on information bits to change the distribution of the selected symbols (e.g., corresponding to constellation points) from a uniform distribution to Quasi-Gaussian distribution (Gaussian distribution may be targeted but also may be difficult to achieve) to improve performance. The shaping bits may be obtained by a decoder in the Tx side such that the codeword encoded by the shaping bits is as similar to the information bits for shaping as possible. In general, the shaping bits may be encoded by an FEC block and transmitted over signed bits of the symbols. In the Rx side, the shaping may be decoded and used to recover the information bits by removing the mask.

Constellation shaping may include a distribution of constellation points 852 (e.g., 4, 8, 16, etc., points) where each of the constellation points 852 may correspond to a unique amplitude and phase for transmission of symbols that represent information bits. CBs of a CBG may utilize block code based constellation shaping, according to aspects herein, to mask one or more of the constellation points 852, and thus mask the symbols corresponding to certain information bits, based on shaping bits. As shown by way of example and not limitation, a masking 854 may be used to mask certain ones of the constellation points 852. The masking 854 based on the shaping bits may be associated with the phase/amplitude of symbol transmissions, and therefore, transmissions may be power-reduced or phase specific as desired.

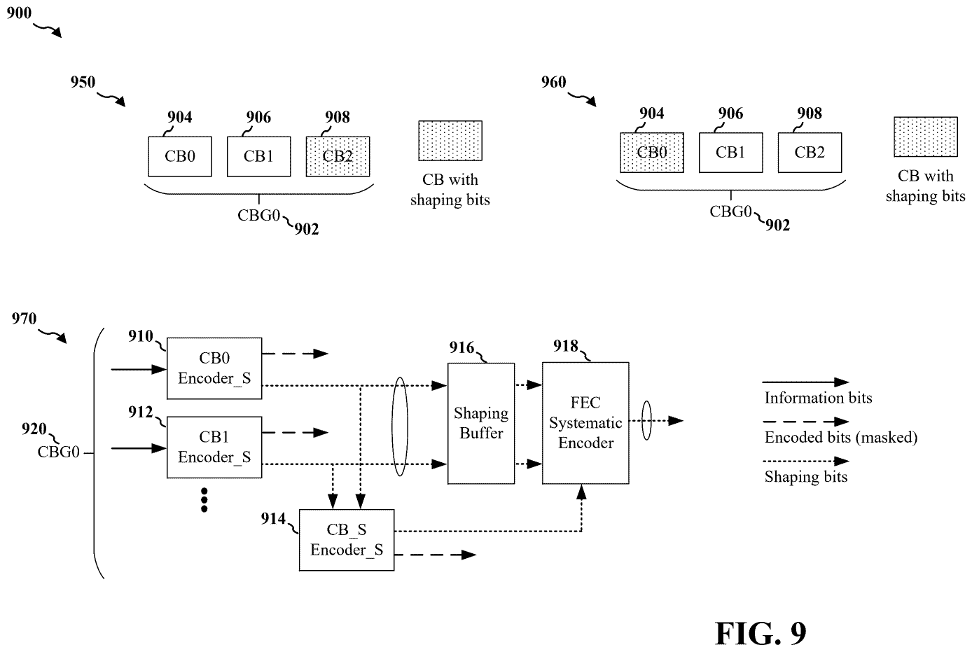

FIG. 9 is a diagram 900 illustrating example configurations for shaping bit transmissions and for block code based constellation shaping of shaping bit CBs, in various aspects. Diagram 900 shows, by way of example, a configuration 950 for shaping bits in a first CB for transmission, a configuration 960 for shaping bits in a last CB for transmission, and a configuration 970 of a Tx node for block code based constellation shaping of shaping bit CBs.

In the configuration 950, a CBG 902 (“CBG0”) is shown as including three CBs, by way of example: a CB 904, a CB 906, and a CB 908. The configuration 950 provides shaping bits for the CBG 902 in the CB 908 (e.g., the last CB in the CBG 902 for transmission). In such a configuration, for each CB except the last CB (e.g., CB 904, CB 906), the generated shaping bits corresponding to that CB may be temporarily stored in a shaping buffer, and the masked information bits and ordinary/non-masked information bits are encoded by an FEC systematic encoder. Thus, aspects improve Tx encoding efficiency/performance by transmitting a shaping bit-specific CB at the end of the CBG (e.g., the CBs within the CBG are encoded without the Tx concurrently handling the transmission of shaping bits.

In the configuration 960, the CBG 902 is shown as including three CBs, by way of example: the CB 904, the CB 906, and the CB 908. However, in contrast to the configuration 950, the configuration 960 provides shaping bits for the CBG 902 in the CB 904 (e.g., the first CB in the CBG 902 for transmission). In such a configuration, for each CB except the first CB (e.g., CB 906, CB 908), the generated shaping bits corresponding to that CB may be temporarily stored in the shaping buffer, and the masked information bits and ordinary/non-masked information bits are encoded by the FEC systematic encoder. Thus, aspects improve Rx latency by transmitting a shaping bit-specific CB at the beginning of the CBG (e.g., the encoded shaping bits are received first and used to decode the subsequently received CBs).

In the configuration 970, as shown, a CBG 920 (“CBG0”) may include multiple CBs. The multiple CBs may include a first set of CBs for information bits (e.g., encoded or not) and a second set of CBs (e.g., one or more) for shaping bits. The CBG 920 may have ones of its information bits for CBs processed by associated encoders, e.g., an encoder 910 for a first CB (CB0), an encoder 912 for a second CB (CB1), etc. The encoder 910 and the encoder 912 may respectively output encoded bits of information and shaping bits for the first CB and the second CB.

As described herein, the shaping bits for a CBG may be transmitted in one or more special CBs within the CBG from which the shaping bits are generated. A shaping encoder 914 (of a CB noted as the “CB_S” block) carrying the shaping bits within the CBG 920 may be an encoder that utilizes block code based constellation shaping. The shaping bits of the encoder 910 and the encoder 912 may be provided to the shaping encoder 914 and to a shaping buffer 916 (e.g., for temporary storage). The shaping encoder 914 may output its encoded bits as well as its own additional shaping bits. These additional shaping bits from the shaping encoder 914 may be provided to an FEC encoder 918, along with the shaping bits stored in the shaping buffer 916, for encoding. The encoded shaping bits may thus represent the shaping bits for all CBs of the CBG 920.

In this manner, a Tx node may be configured to encode the shaping bits, e.g., using the shaping encoder 914, by generating additional shaping bits based on the shaping bits of other CBs and encoding the shaping bits and the additional shaping bits using block code-based constellation shaping. In other words, the shaping bits encoded by the shaping encoder 914 may be further shaped themselves. In this way, additional shaping bits for the CB having the encoded shaping bits may be used to further shape the CBG 920 and improve performance with block code based constellation shaping of the CB with the shaping bits. Accordingly, the shaping bits for all of the CBs in the CBG 920 may be included in one CB and may also be processed for block-code based constellation shaping.

The encoded shaping bits and the information bits (encoded or otherwise) may be provided for further processing and transmission of the CBG 920 to an Rx, as described herein. For instance, generated parity bits and all shaping bits may be mapped to sign bits, and if the total number of such bits is larger than the amplitude symbol length, then the extra bits may be mapped to the least significant bit positions. Involved information bits for the shaping encoder 914 may be mapped to non-sign positions of the CBG 920.

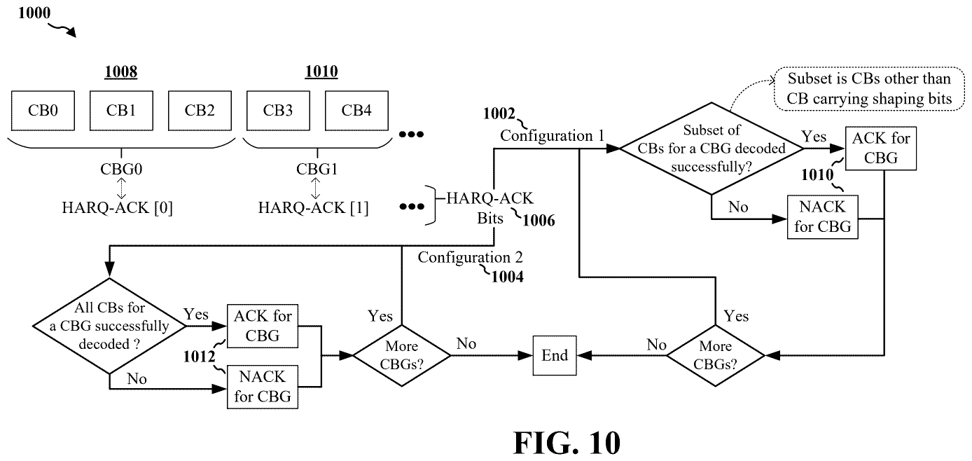

FIG. 10 is a diagram 1000 illustrating examples of decoding acknowledgement/negative acknowledgement, in various aspects. Diagram 1000 is shown and described in the context of HARQ-ACKs and HARQ-NACKs, by way of example and not limitation. In diagram 1000, a configuration 1002 and a configuration 1004 are illustrated for Rx node decoding responses of a CBG 1008 and a CBG 1010 (e.g., two CBGs shown in the illustrated aspect) using HARQ-ACK bits 1006 for ACKs and/or NACKs.

In contrast to prior implementations for which an ACK is reported for a CBG if the corresponding CBG has been successfully decoded and a NACK is reported for all the CBGs if the TB CRC check fails while the CB CRCs check for all the CBs, the configuration 1002 and the configuration 1004 may be based on ACKs/NACKs for individual CBGs (e.g., a correspondence of each HARQ-ACK bit to each CBG (e.g., the CBG 1008, the CBG 1010, etc.)), as well as a CB of a CBG including all the shaping bits for the CBG, which may improve false alarm mitigation.

In the configuration 1002, an ACK may be reported for a CBG if all the CBs other than the CB carrying shaping bits in the corresponding CBG have been successfully decoded, while a NACK may be reported for a CBG if one CB other than the CB carrying shaping bits in the corresponding CBG fails decoding.

For instance, when a CBG is received according to the configuration 1002, an ACK/NACK for the CBG may be transmitted (at 1010) to a Tx node based on a subset of CBs for the CBG being successfully decoded (e.g., where the subset is the CBs other than the CB carrying the shaping bits). In aspects, an Rx node transmits, for a Tx node, at least one of a HARQ-ACK for the transmitted CBG that indicates a successful decode for both of the first set of one or more CBs, the first set of one or more CBs comprising the encoded information bits that are encoded based on the shaping bits, and the unencoded information bits, or a HARQ-NACK for the transmitted CBG that indicates an unsuccessful decode for at least one CB of the first set of one or more CBs, the first set of one or more CBs comprising the encoded information bits that are encoded based on the shaping bits, or the unencoded information bits.

In the configuration 1004, an ACK may be reported for a CBG if all the CBs other than CB carrying shaping bits in the corresponding CBG have been successfully decoded, while a NACK may be reported for a CBG if one CB other than the CB carrying shaping bits in the corresponding CBG fails decoding.

For instance, when a CBG is received according to the configuration 1004, an ACK/NACK for the CBG may be transmitted (at 1012) to a Tx node based on all CBs for the CBG being successfully decoded. In aspects, an Rx node transmits, for a Tx node, at least one of a HARQ-ACK for the transmitted CBG, where the HARQ-ACK indicates a successful decode of each CB of the transmitted CBG, or a HARQ-NACK for the transmitted CBG, where the HARQ-NACK indicates an unsuccessful decode for at least one CB of the transmitted CBG.

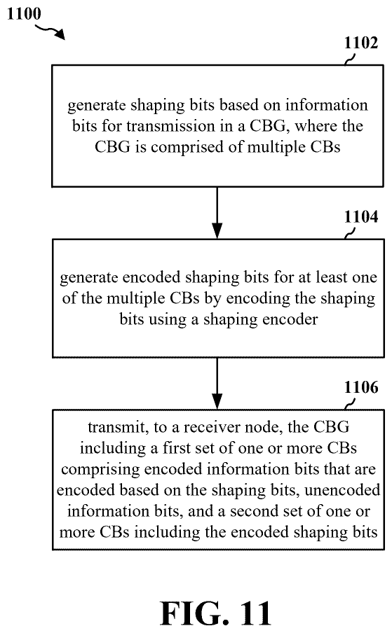

FIG. 11 is a flowchart 1100 of a method of wireless communication, in various aspects. The method may be performed by a Tx node of a UE, a base station, and/or the like (e.g., the UE 104; the base station 102; the Tx node 702; the apparatus 1504; the network entity 1502, 1602). In some aspects, the method may include aspects described in connection with the communication flow in FIG. 7 and/or aspects described in FIGS. 8-10. The method provides for transmission of shaping bits within a CBG for block-code based constellation shaping that allows a greater range of shaping rates and improve shaping performance, improves Rx latency and Tx encoding efficiency/performance, and improves encoding block performance.

At 1102, a Tx node generates shaping bits based on information bits for transmission in a CBG, where the CBG is comprised of multiple CBs. As an example, the generation may be performed, at least in part, by the component 198. FIGS. 7-10 illustrate an example of the Tx node 702 generating such information bits.

The Tx node 702 may be configured to generate (at 706) shaping bits based on information bits for transmission in a CBG 710 (e.g., 802 in FIG. 8; 902, 920 in FIG. 9; 1006, 1008 in FIG. 10). In aspects, the CBG 710 (e.g., 802 in FIG. 8; 902, 920 in FIG. 9; 1006, 1008 in FIG. 10) may include multiple CBs (e.g., 904, 906, 908 in FIG. 9), as described herein, e.g., a first set of CBs (e.g., 904-906, 906-908 in FIG. 9) and a second set of CBs (e.g., 904, 908 in FIG. 9). The first set of CBs (e.g., 904-906, 906-908 in FIG. 9) for the CBG 710 (e.g., 802 in FIG. 8; 902, 920 in FIG. 9; 1006, 1008 in FIG. 10) may include encoded information bits that are encoded based on the shaping bits, and the second set of CBs (e.g., one or more CBs) (e.g., 904, 908 in FIG. 9) may include encoded shaping bits. That is, according to aspects herein, a CBG may include a specific CB for transmission of the encoded shaping bits. CBs (e.g., 904, 906, 908 in FIG. 9) of the CBG 710 (e.g., 802 in FIG. 8; 902, 920 in FIG. 9; 1006, 1008 in FIG. 10) may also include unencoded information bits. The Tx node 702 may be configured to generate (at 706) the shaping bits using a decoder of a shaping encoder (e.g., 808 in FIG. 8; 914 in FIG. 9) that decodes the information bits.

At 1104, the Tx node generates encoded shaping bits for at least one of the multiple CBs by encoding the shaping bits using a shaping encoder. As an example, the generation may be performed, at least in part, by the component 198. FIGS. 7-10 illustrate an example of the Tx node 702 generating such encoded shaping bits.

The Tx node 702 may be configured to generate (at 708) encoded shaping bits for at least one of the multiple CBs (e.g., 904, 906, 908 in FIG. 9) by encoding the shaping bits using the shaping encoder (e.g., 808 in FIG. 8; 914 in FIG. 9). In some aspects, the shaping encoder (e.g., 808 in FIG. 8; 914 in FIG. 9) may be configured to generate (at 708) the encoded shaping bits, which may be included in a specific CB, by encoding using block code-based constellation shaping (e.g., 850 in FIG. 8). That is, the shaping bits may be configured to alter a distribution, e.g., by masking the information bits, of at least one symbol in the CBG for the block code-based constellation shaping (e.g., 850 in FIG. 8). In other aspects, the FEC encoder (e.g., 918 in FIG. 9) may be configured to generate (at 708) the encoded shaping bits, which may be included in a specific CB, by encoding using a coding scheme that is different from block code-based constellation shaping (e.g., 850 in FIG. 8), e.g., using FEC. The Tx node 702 may also be configured to generate encoded information bits for another of the multiple CBs (e.g., 904, 906, 908 in FIG. 9) by encoding a portion of the information bits for the CBG using the shaping bits. In aspects, at least one of encoding the shaping bits (e.g., at 706) or encoding the portion of the information bits for the CBG using the shaping bits may include encoding based on an FEC encoder(s) (e.g., 918 in FIG. 9).

The Tx node 702 may be configured to encode the shaping bits, e.g., using the shaping encoder (e.g., 808 in FIG. 8; 914 in FIG. 9), by generating additional shaping bits based on the shaping bits of other CBs (e.g., 904, 906, 908 in FIG. 9) and encoding the shaping bits and the additional shaping bits using block code-based constellation shaping (e.g., 850 in FIG. 8). For example, the shaping bits encoded by the shaping encoder (e.g., 808 in FIG. 8; 914 in FIG. 9) may be further shaped themselves. In this way, additional shaping bits for the CB having the encoded shaping bits may be used to further shape the CBG and improve performance with block code based constellation shaping (e.g., 850 in FIG. 8) of the CB with the shaping bits.

In aspects, to generate (at 708) the encoded shaping bits by encoding the shaping bits using the shaping encoder (e.g., 808 in FIG. 8; 914 in FIG. 9), the Tx node 702 may be configured to generate at least one parity bit for the CBG based on encoding the shaping bits, e.g., using the FEC encoder (e.g., 918 in FIG. 9), and may be configured to map the at least one parity bit, the shaping bits, and the additional shaping bits to sign bits of the CBG and to map at least one information bit of the at least one of the multiple CBs (e.g., 904, 906, 908 in FIG. 9) to at least one non-sign bit of the CBG, respectively, e.g., using a bit-to-symbol mapper. Regarding the mapping by the Tx node 702 of the at least one information bit of the at least one of the multiple CBs (e.g., 904, 906, 908 in FIG. 9) to at least one non-sign bit of the CBG, respectively, the Tx node 702 may be configured to map a specific information bit to a specific non-sign bit of the CBG, and may be configured to perform such mapping for each information bit to a corresponding (e.g., different) non-sign bit.

At 1106, the Tx node transmits, to an Rx node, the CBG including a first set of one or more CBs comprising encoded information bits that are encoded based on the shaping bits, unencoded information bits, and a second set of one or more CBs including the encoded shaping bits. As an example, the transmission may be performed, at least in part, by the component 198. FIGS. 7-10 illustrate an example of the Tx node 702 transmitting such a CBG to an Rx node (e.g., the Rx node 704).

The Tx node 702 may be configured to transmit, to the receiver node 704 which may be configured to receive, the CBG 710 (e.g., 802 in FIG. 8; 902, 920 in FIG. 9; 1006, 1008 in FIG. 10). As noted, the CBG 710 (e.g., 802 in FIG. 8; 902, 920 in FIG. 9; 1006, 1008 in FIG. 10) may include a first set of one or more CBs (e.g., 904-906, 906-908 in FIG. 9) that having the encoded information bits that are encoded based on the shaping bits, the CBG 710 (e.g., 802 in FIG. 8; 902, 920 in FIG. 9; 1006, 1008 in FIG. 10) may include the unencoded information bits, and the CBG 710 (e.g., 802 in FIG. 8; 902, 920 in FIG. 9; 1006, 1008 in FIG. 10) may include the second set of one or more CBs (e.g., 904, 908 in FIG. 9) including the encoded shaping bits. In aspects, the one(s) of the multiple CBs (e.g., 904, 908 in FIG. 9) that includes the encoded shaping bits may include a first CB (e.g., 904 in FIG. 9) of the multiple CBs (e.g., 904, 906, 908 in FIG. 9) that is transmitted, or may include a final CB (e.g., 908 in FIG. 9) of the multiple CBs (e.g., 904, 906, 908 in FIG. 9) that is transmitted. For instance, a CB (e.g., 904, 906, 908 in FIG. 9) with the encoded shaping bits may be transmitted as the first of the CBs in the CBG, or may be transmitted as a last of the CBs (e.g., 908 in FIG. 9), or final CB, in the CBG.

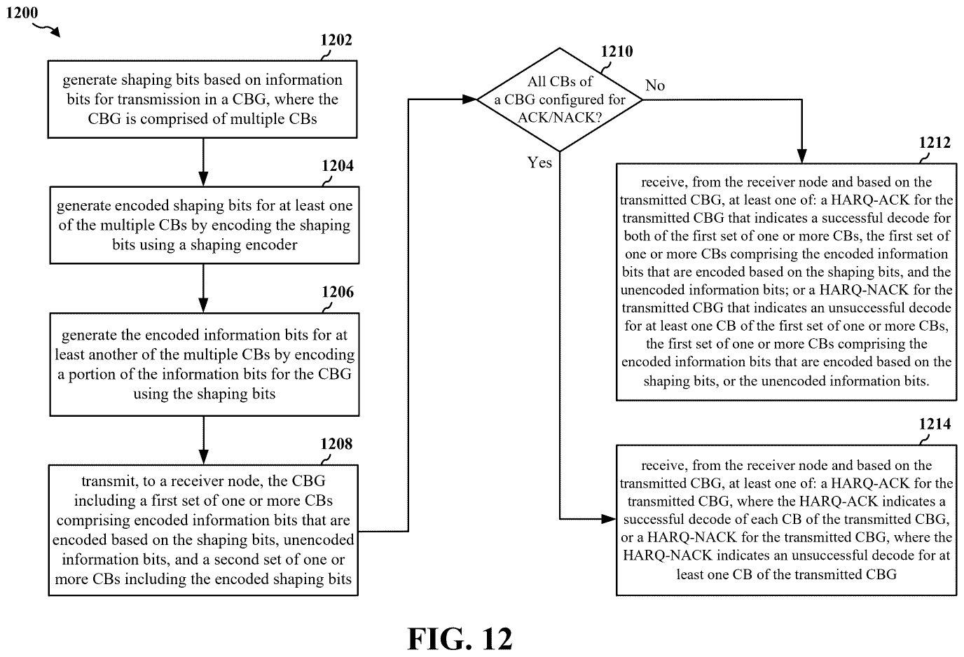

FIG. 12 is a flowchart 1200 of a method of wireless communication, in various aspects. The method may be performed by a Tx node of a UE, a base station, and/or the like (e.g., the UE 104; the base station 102; the Tx node 702; the apparatus 1504; the network entity 1502, 1602). In some aspects, the method may include aspects described in connection with the communication flow in FIG. 7 and/or aspects described in FIGS. 8-10. The method provides for transmission of shaping bits within a CBG for block-code based constellation shaping that allows a greater range of shaping rates and improve shaping performance, improves Rx latency and Tx encoding efficiency/performance, and improves encoding block performance.

At 1202, a Tx node generates shaping bits based on information bits for transmission in a CBG, where the CBG is comprised of multiple CBs. As an example, the generation may be performed, at least in part, by the component 198. FIGS. 7-10 illustrate an example of the Tx node 702 generating such information bits.

The Tx node 702 may be configured to generate (at 706) shaping bits based on information bits for transmission in a CBG 710 (e.g., 802 in FIG. 8; 902, 920 in FIG. 9; 1006, 1008 in FIG. 10). In aspects, the CBG 710 (e.g., 802 in FIG. 8; 902, 920 in FIG. 9; 1006, 1008 in FIG. 10) may include multiple CBs (e.g., 904, 906, 908 in FIG. 9), as described herein, e.g., a first set of CBs (e.g., 904-906, 906-908 in FIG. 9) and a second set of CBs (e.g., 904, 908 in FIG. 9). The first set of CBs (e.g., 904-906, 906-908 in FIG. 9) for the CBG 710 (e.g., 802 in FIG. 8; 902, 920 in FIG. 9; 1006, 1008 in FIG. 10) may include encoded information bits that are encoded based on the shaping bits, and the second set of CBs (e.g., one or more CBs) (e.g., 904, 908 in FIG. 9) may include encoded shaping bits. That is, according to aspects herein, a CBG may include a specific CB for transmission of the encoded shaping bits. CBs (e.g., 904, 906, 908 in FIG. 9) of the CBG 710 (e.g., 802 in FIG. 8; 902, 920 in FIG. 9; 1006, 1008 in FIG. 10) may also include unencoded information bits. The Tx node 702 may be configured to generate (at 706) the shaping bits using a decoder of a shaping encoder (e.g., 808 in FIG. 8; 914 in FIG. 9) that decodes the information bits.

At 1204, the Tx node generates encoded shaping bits for at least one of the multiple CBs by encoding the shaping bits using a shaping encoder. As an example, the generation may be performed, at least in part, by the component 198. FIGS. 7-10 illustrate an example of the Tx node 702 generating such encoded shaping bits.

The Tx node 702 may be configured to generate (at 708) encoded shaping bits for at least one of the multiple CBs (e.g., 904, 906, 908 in FIG. 9) by encoding the shaping bits using the shaping encoder (e.g., 808 in FIG. 8; 914 in FIG. 9). In some aspects, the shaping encoder (e.g., 808 in FIG. 8; 914 in FIG. 9) may be configured to generate (at 708) the encoded shaping bits, which may be included in a specific CB, by encoding using block code-based constellation shaping (e.g., 850 in FIG. 8). That is, the shaping bits may be configured to alter a distribution, e.g., by masking the information bits, of at least one symbol in the CBG for the block code-based constellation shaping (e.g., 850 in FIG. 8). In other aspects, the FEC encoder (e.g., 918 in FIG. 9) may be configured to generate (at 708) the encoded shaping bits, which may be included in a specific CB, by encoding using a coding scheme that is different from block code-based constellation shaping (e.g., 850 in FIG. 8), e.g., using FEC.

In aspects, at least one of encoding the shaping bits (e.g., at 706) or encoding the portion of the information bits for the CBG using the shaping bits may include encoding based on an FEC encoder(s) (e.g., 918 in FIG. 9). The Tx node 702 may be configured to encode the shaping bits, e.g., using the shaping encoder (e.g., 808 in FIG. 8; 914 in FIG. 9), by generating additional shaping bits based on the shaping bits of other CBs (e.g., 904, 906, 908 in FIG. 9) and encoding the shaping bits and the additional shaping bits using block code-based constellation shaping (e.g., 850 in FIG. 8). For example, the shaping bits encoded by the shaping encoder (e.g., 808 in FIG. 8; 914 in FIG. 9) may be further shaped themselves. In this way, additional shaping bits for the CB having the encoded shaping bits may be used to further shape the CBG and improve performance with block code based constellation shaping (e.g., 850 in FIG. 8) of the CB with the shaping bits.

In aspects, to generate (at 708) the encoded shaping bits by encoding the shaping bits using the shaping encoder (e.g., 808 in FIG. 8; 914 in FIG. 9), the Tx node 702 may be configured to generate at least one parity bit for the CBG based on encoding the shaping bits, e.g., using the FEC encoder (e.g., 918 in FIG. 9), and may be configured to map the at least one parity bit, the shaping bits, and the additional shaping bits to sign bits of the CBG and to map at least one information bit of the at least one of the multiple CBs (e.g., 904, 906, 908 in FIG. 9) to at least one non-sign bit of the CBG, respectively, e.g., using a bit-to-symbol mapper. Regarding the mapping by the Tx node 702 of the at least one information bit of the at least one of the multiple CBs (e.g., 904, 906, 908 in FIG. 9) to at least one non-sign bit of the CBG, respectively, the Tx node 702 may be configured to map a specific information bit to a specific non-sign bit of the CBG, and may be configured to perform such mapping for each information bit to a corresponding (e.g., different) non-sign bit.

At 1206, the Tx node generates the encoded information bits for at least another of the multiple CBs by encoding a portion of the information bits for the CBG using the shaping bits. As an example, the generation may be performed, at least in part, by the component 198. FIGS. 7-10 illustrate an example of the Tx node 702 generating such encoded information bits.

The Tx node 702 may also be configured to generate encoded information bits for another of the multiple CBs (e.g., 904, 906, 908 in FIG. 9) by encoding a portion of the information bits for the CBG using the shaping bits. In aspects, at least one of encoding the shaping bits (e.g., at 706) or encoding the portion of the information bits for the CBG using the shaping bits may include encoding based on an FEC encoder(s) (e.g., 918 in FIG. 9). In aspects, at least one of encoding the shaping bits (e.g., at 706) or encoding the portion of the information bits for the CBG using the shaping bits may include encoding based on an FEC encoder(s) (e.g., 918 in FIG. 9). The Tx node 702 may be configured to encode the shaping bits, e.g., using the shaping encoder (e.g., 808 in FIG. 8; 914 in FIG. 9), by generating additional shaping bits based on the shaping bits of other CBs (e.g., 904, 906, 908 in FIG. 9) and encoding the shaping bits and the additional shaping bits using block code-based constellation shaping (e.g., 850 in FIG. 8). For example, the shaping bits encoded by the shaping encoder (e.g., 808 in FIG. 8; 914 in FIG. 9) may be further shaped themselves. In this way, additional shaping bits for the CB having the encoded shaping bits may be used to further shape the CBG and improve performance with block code based constellation shaping (e.g., 850 in FIG. 8) of the CB with the shaping bits. In aspects, the Tx node 702 may be configured to generate at least one parity bit for the CBG based on encoding the shaping bits, e.g., using the FEC encoder (e.g., 918 in FIG. 9), and may be configured to map the at least one parity bit, the shaping bits, and the additional shaping bits to sign bits of the CBG and to map at least one information bit of the at least one of the multiple CBs (e.g., 904, 906, 908 in FIG. 9) to at least one non-sign bit of the CBG, respectively, e.g., using a bit-to-symbol mapper. Regarding the mapping by the Tx node 702 of the at least one information bit of the at least one of the multiple CBs (e.g., 904, 906, 908 in FIG. 9) to at least one non-sign bit of the CBG, respectively, the Tx node 702 may be configured to map a specific information bit to a specific non-sign bit of the CBG, and may be configured to perform such mapping for each information bit to a corresponding (e.g., different) non-sign bit.

At 1208, the Tx node transmits, to an Rx node, the CBG including a first set of one or more CBs comprising encoded information bits that are encoded based on the shaping bits, unencoded information bits, and a second set of one or more CBs including the encoded shaping bits. As an example, the transmission may be performed, at least in part, by the component 198. FIGS. 7-10 illustrate an example of the Tx node 702 transmitting such a CBG to an Rx node (e.g., the Rx node 704).

The Tx node 702 may be configured to transmit, to the receiver node 704 which may be configured to receive, the CBG 710 (e.g., 802 in FIG. 8; 902, 920 in FIG. 9; 1006, 1008 in FIG. 10). As noted, the CBG 710 (e.g., 802 in FIG. 8; 902, 920 in FIG. 9; 1006, 1008 in FIG. 10) may include a first set of one or more CBs (e.g., 904-906, 906-908 in FIG. 9) that having the encoded information bits that are encoded based on the shaping bits, the CBG 710 (e.g., 802 in FIG. 8; 902, 920 in FIG. 9; 1006, 1008 in FIG. 10) may include the unencoded information bits, and the CBG 710 (e.g., 802 in FIG. 8; 902, 920 in FIG. 9; 1006, 1008 in FIG. 10) may include the second set of one or more CBs (e.g., 904, 908 in FIG. 9) including the encoded shaping bits. In aspects, the one(s) of the multiple CBs (e.g., 904, 908 in FIG. 9) that includes the encoded shaping bits may include a first CB (e.g., 904 in FIG. 9) of the multiple CBs (e.g., 904, 906, 908 in FIG. 9) that is transmitted, or may include a final CB (e.g., 908 in FIG. 9) of the multiple CBs (e.g., 904, 906, 908 in FIG. 9) that is transmitted. For instance, a CB (e.g., 904, 906, 908 in FIG. 9) with the encoded shaping bits may be transmitted as the first of the CBs in the CBG, or may be transmitted as a last of the CBs (e.g., 908 in FIG. 9), or final CB, in the CBG.

At 1210, it is determined if the Tx node is configured for ACK/NACK responses based on all CBs of a CBG (e.g., as for the configuration 1004 in FIG. 10). If so, the flowchart 1200 continues to 1214. If not, e.g., as for the configuration 1002 in FIG. 10, the flowchart 1200 continues to 1212. As an example, the estimation may be performed, at least in part, by the component 198. FIGS. 7, 10 illustrate an example of the Tx node 702 determining ACK/NACK configurations.

At 1212, the Tx node receives, from the received node and based on the transmitted CBG, at least one of: a HARQ-ACK for the received CBG that indicates a successful decode for at least one CB of the first set of one or more CBs, the first set of one or more CBs comprising the encoded information bits that are encoded based on the shaping bits, or the unencoded information bits; or a HARQ-NACK for the received CBG, where the HARQ-NACK indicates an unsuccessful decode for at least one CB of the set of one or more CBs. As an example, the reception may be performed, at least in part, by the component 198. FIGS. 7, 10 illustrate an example of the Tx node 702 receiving HARQ-ACKs/NACKs from an Rx node (e.g., the Rx node 704).

The Rx node 704 may also notify the Tx node 702 as to whether the CBG 710 (e.g., 802 in FIG. 8; 902, 920 in FIG. 9; 1006, 1008 in FIG. 10) was properly decoded. For instance, the Rx node 704 may be configured to transmit, and the Tx node 702 may be configured to receive, an ACK/NACK 716 that is associated with the decoding of the CBG 710 (e.g., 802 in FIG. 8; 902, 920 in FIG. 9; 1006, 1008 in FIG. 10). In aspects, the ACK/NACK 716 may be a HARQ-ACK or a HARQ-NACK.

In one example, for a first ACK/NACK configuration (e.g., 1002 in FIG. 10), the Rx node 704 may be configured to transmit (e.g., at 1010 in FIG. 10), and the Tx node 702 may be configured to receive, as the ACK/NACK 716, a HARQ-ACK for the CBG 710 (e.g., 802 in FIG. 8; 902, 920 in FIG. 9; 1006, 1008 in FIG. 10) (e.g., that indicates a successful decode for at least one CB of the first set of one or more CBs (e.g., 904-906, 906-908 in FIG. 9), the first set of one or more CBs (e.g., 904-906, 906-908 in FIG. 9) comprising the encoded information bits that are encoded based on the shaping bits, or the unencoded information bits), or a HARQ-NACK for the received CBG (e.g., where the HARQ-NACK indicates an unsuccessful decode for at least one CB of the set of one or more CBs (e.g., 904, 906, 908 in FIG. 9)). At 1214, the Tx node receives, from the transmitter node and based on the transmitted CBG, at least one of: a HARQ-ACK for the received CBG, where the HARQ-ACK indicates a successful decode for each CB of the received CBG, or a HARQ-NACK for the received CBG, where the HARQ-NACK that indicates an unsuccessful decode for at least one CB of the received CBG. As an example, the reception may be performed, at least in part, by the component 198. FIGS. 7, 10 illustrate an example of the Tx node 702 receiving HARQ-ACKs/NACKs from an Rx node (e.g., the Rx node 704).

The Rx node 704 may also notify the Tx node 702 as to whether the CBG 710 (e.g., 802 in FIG. 8; 902, 920 in FIG. 9; 1006, 1008 in FIG. 10) was properly decoded. For instance, the Rx node 704 may be configured to transmit, and the Tx node 702 may be configured to receive, an ACK/NACK 716 that is associated with the decoding of the CBG 710 (e.g., 802 in FIG. 8; 902, 920 in FIG. 9; 1006, 1008 in FIG. 10). In aspects, the ACK/NACK 716 may be a HARQ-ACK or a HARQ-NACK.

In another example, for a second ACK/NACK configuration (e.g., 1004 in FIG. 10), the Rx node 704 may be configured to transmit (e.g., at 1012 in FIG. 10), and the Tx node 702 may be configured to receive, as the ACK/NACK 716, a HARQ-ACK for the transmitted CBG (e.g., where the HARQ-ACK indicates a successful decode of each CB (e.g., 904, 906, 908 in FIG. 9) of the transmitted CBG), or a HARQ-NACK for the transmitted CBG (e.g., where the HARQ-NACK indicates an unsuccessful decode for at least one CB (e.g., 904, 906, 908 in FIG. 9) of the transmitted CBG).

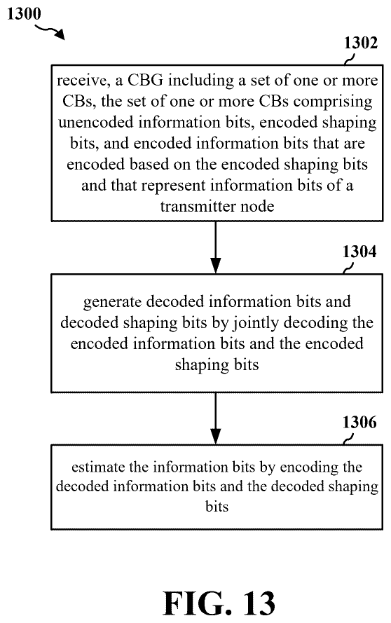

FIG. 13 is a flowchart 1300 of a method of wireless communication, in various aspects. The method may be performed by a Tx node of a UE, a base station, and/or the like (e.g., the UE 104; the base station 102; the Tx node 702; the apparatus 1504; the network entity 1502, 1602). In some aspects, the method may include aspects described in connection with the communication flow in FIG. 7 and/or aspects described in FIGS. 8-10. The method provides for transmission of shaping bits within a CBG for block-code based constellation shaping that allows a greater range of shaping rates and improve shaping performance, improves Rx latency and Tx encoding efficiency/performance, and improves encoding block performance.

At 1302, an Rx node receives, a CBG including a set of one or more CBs, the set of one or more CBs comprising unencoded information bits, encoded shaping bits, and encoded information bits that are encoded based on the encoded shaping bits and that represent information bits of a transmitter node. As an example, the reception may be performed, at least in part, by the component 199. FIGS. 7-10 illustrate an example of the Rx node 704 receiving such a CBG from a Tx node (e.g., the Tx node 702).

The Tx node 702 may be configured to transmit, to the receiver node 704 which may be configured to receive, the CBG 710 (e.g., 802 in FIG. 8; 902, 920 in FIG. 9; 1006, 1008 in FIG. 10). As noted, the CBG 710 (e.g., 802 in FIG. 8; 902, 920 in FIG. 9; 1006, 1008 in FIG. 10) may include a first set of one or more CBs (e.g., 904-906, 906-908 in FIG. 9) that having the encoded information bits that are encoded based on the shaping bits, the CBG 710 (e.g., 802 in FIG. 8; 902, 920 in FIG. 9; 1006, 1008 in FIG. 10) may include the unencoded information bits, and 710 (e.g., 802 in FIG. 8; 902, 920 in FIG. 9; 1006, 1008 in FIG. 10) may include the second set of one or more CBs (e.g., 904, 908 in FIG. 9) including the encoded shaping bits. In aspects, the one(s) of the multiple CBs (e.g., 904, 906, 908 in FIG. 9) that includes the encoded shaping bits may include a first CB (e.g., 904 in FIG. 9) of the multiple CBs (e.g., 904, 906, 908 in FIG. 9) that is transmitted, or may include a final CB (e.g., 908 in FIG. 9) of the multiple CBs (e.g., 904, 906, 908 in FIG. 9) that is transmitted. For instance, a CB (e.g., 904, 906, 908 in FIG. 9) with the encoded shaping bits may be transmitted as the first of the CBs (e.g., 904 in FIG. 9) in the CBG, or may be transmitted as a last of the CBs (e.g., 908 in FIG. 9), or final CB, in the CBG.

At 1304, the Rx node generates decoded information bits and decoded shaping bits by jointly decoding the encoded information bits and the encoded shaping bits. As an example, the generation may be performed, at least in part, by the component 199. FIGS. 7-10 illustrate an example of the Rx node 704 generating such decoded information bits and decoded shaping bits.

Subsequent to receiving the CBG 710 (e.g., 802 in FIG. 8; 902, 920 in FIG. 9; 1006, 1008 in FIG. 10) from the Tx node 702, the Rx node 704 may be configured to generate (at 712) decoded information bits and decoded shaping bits by jointly decoding the encoded information bits and the encoded shaping bits. In aspects, the Rx node 704 may be configured to jointly decoding the encoded information bits and the encoded shaping bits for the CBG by decoding at least one FEC encoding. As noted above, the encoded shaping bits that is Rx node 704 is configured to decode (e.g., at 712) may include additional encoded shaping bits, such as additional shaping bits specifically for the CB that includes the shaping bits, which may be associated with block code-based constellation shaping (e.g., 850 in FIG. 8) for the encoded shaping bits. In such aspects, jointly decoding the encoded information bits and the encoded shaping bits by the Rx node 704 may include decoding the additional encoded shaping bits. In aspects, the Rx node 704 may be configured to jointly decode the encoded information bits and the encoded shaping bits by decoding a first mapping of at least one parity bit, the encoded shaping bits, and the additional encoded shaping bits from sign bits of the CBG, and decoding a second mapping of at least one information bit from at least one non-sign bit of the CBG, respectively (e.g., decoding the bitwise mapping of each information bit with each corresponding non-sign bit). At 1306, the Rx node estimates the information bits by encoding the decoded information bits and the decoded shaping bits. As an example, the estimation may be performed, at least in part, by the component 199. FIGS. 7-10 illustrate an example of the Rx node 704 estimating such information bits.

The Rx node 704 may be configured to estimate (at 714) the information bits by encoding the decoded information bits and the decoded shaping bits. For example, the Rx node 704 may reencode the decoded information bits and/or the decoded shaping bits in order to estimate (at 714) the original information bits.

The Rx node 704 may also notify the Tx node 702 as to whether the CBG 710 (e.g., 802 in FIG. 8; 902, 920 in FIG. 9; 1006, 1008 in FIG. 10) was properly decoded. For instance, the Rx node 704 may be configured to transmit, and the Tx node 702 may be configured to receive, an ACK/NACK 716 that is associated with the decoding of the CBG 710 (e.g., 802 in FIG. 8; 902, 920 in FIG. 9; 1006, 1008 in FIG. 10). In aspects, the ACK/NACK 716 may be a HARQ-ACK or a HARQ-NACK.

In one example, for a first ACK/NACK configuration (e.g., 1002 in FIG. 10), the Rx node 704 may be configured to transmit (e.g., at 1010 in FIG. 10), and the Tx node 702 may be configured to receive, as the ACK/NACK 716, a HARQ-ACK for the CBG 710 (e.g., 802 in FIG. 8; 902, 920 in FIG. 9; 1006, 1008 in FIG. 10) (e.g., that indicates a successful decode for at least one CB of the first set of one or more CBs (e.g., 904-906, 906-908 in FIG. 9), the first set of one or more CBs (e.g., 904-906, 906-908 in FIG. 9) comprising the encoded information bits that are encoded based on the shaping bits, or the unencoded information bits), or a HARQ-NACK for the received CBG (e.g., where the HARQ-NACK indicates an unsuccessful decode for at least one CB of the set of one or more CBs (e.g., 904, 906, 908 in FIG. 9)). In another example, for a second ACK/NACK configuration (e.g., 1004 in FIG. 10), the Rx node 704 may be configured to transmit (e.g., at 1012 in FIG. 10), and the Tx node 702 may be configured to receive, as the ACK/NACK 716, a HARQ-ACK for the transmitted CBG (e.g., where the HARQ-ACK indicates a successful decode of each CB (e.g., 904, 906, 908 in FIG. 9) of the transmitted CBG), or a HARQ-NACK for the transmitted CBG (e.g., where the HARQ-NACK indicates an unsuccessful decode for at least one CB (e.g., 904, 906, 908 in FIG. 9) of the transmitted CBG).

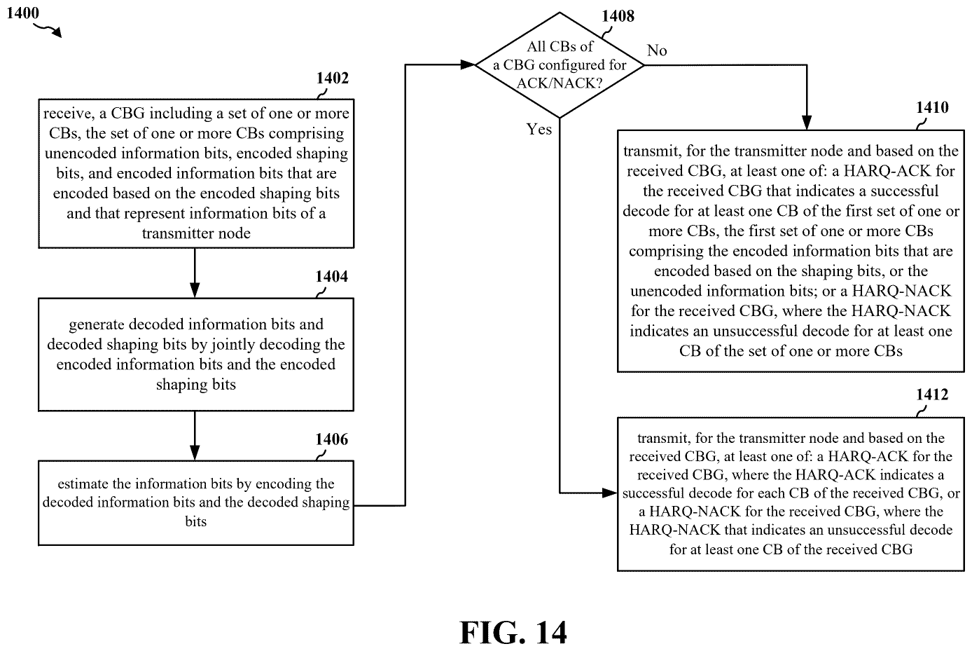

FIG. 14 is a flowchart 1400 of a method of wireless communication, in various aspects. The method may be performed by a Tx node of a UE, a base station, and/or the like (e.g., the UE 104; the base station 102; the Tx node 702; the apparatus 1504; the network entity 1502, 1602). In some aspects, the method may include aspects described in connection with the communication flow in FIG. 7 and/or aspects described in FIGS. 8-10. The method provides for transmission of shaping bits within a CBG for block-code based constellation shaping that allows a greater range of shaping rates and improve shaping performance, improves Rx latency and Tx encoding efficiency/performance, and improves encoding block performance.

At 1402, an Rx node receives, a CBG including a set of one or more CBs, the set of one or more CBs comprising unencoded information bits, encoded shaping bits, and encoded information bits that are encoded based on the encoded shaping bits and that represent information bits of a transmitter node. As an example, the reception may be performed, at least in part, by the component 199. FIGS. 7-10 illustrate an example of the Rx node 704 receiving such a CBG from a Tx node (e.g., the Tx node 702).

The Tx node 702 may be configured to transmit, to the receiver node 704 which may be configured to receive, the CBG 710 (e.g., 802 in FIG. 8; 902, 920 in FIG. 9; 1006, 1008 in FIG. 10). As noted, the CBG 710 (e.g., 802 in FIG. 8; 902, 920 in FIG. 9; 1006, 1008 in FIG. 10) may include a first set of one or more CBs (e.g., 904-906, 906-908 in FIG. 9) that having the encoded information bits that are encoded based on the shaping bits, the CBG 710 (e.g., 802 in FIG. 8; 902, 920 in FIG. 9; 1006, 1008 in FIG. 10) may include the unencoded information bits, and 710 (e.g., 802 in FIG. 8; 902, 920 in FIG. 9; 1006, 1008 in FIG. 10) may include the second set of one or more CBs (e.g., 904, 908 in FIG. 9) including the encoded shaping bits. In aspects, the one(s) of the multiple CBs (e.g., 904, 906, 908 in FIG. 9) that includes the encoded shaping bits may include a first CB (e.g., 904 in FIG. 9) of the multiple CBs (e.g., 904, 906, 908 in FIG. 9) that is transmitted, or may include a final CB (e.g., 908 in FIG. 9) of the multiple CBs (e.g., 904, 906, 908 in FIG. 9) that is transmitted. For instance, a CB (e.g., 904, 906, 908 in FIG. 9) with the encoded shaping bits may be transmitted as the first of the CBs (e.g., 904 in FIG. 9) in the CBG, or may be transmitted as a last of the CBs (e.g., 908 in FIG. 9), or final CB, in the CBG.

At 1404, the Rx node generates decoded information bits and decoded shaping bits by jointly decoding the encoded information bits and the encoded shaping bits. As an example, the generation may be performed, at least in part, by the component 199. FIGS. 7-10 illustrate an example of the Rx node 704 generating such decoded information bits and decoded shaping bits.

Subsequent to receiving the CBG 710 (e.g., 802 in FIG. 8; 902, 920 in FIG. 9; 1006, 1008 in FIG. 10) from the Tx node 702, the Rx node 704 may be configured to generate (at 712) decoded information bits and decoded shaping bits by jointly decoding the encoded information bits and the encoded shaping bits. In aspects, the Rx node 704 may be configured to jointly decoding the encoded information bits and the encoded shaping bits for the CBG by decoding at least one FEC encoding. As noted above, the encoded shaping bits that is Rx node 704 is configured to decode (e.g., at 712) may include additional encoded shaping bits, such as additional shaping bits specifically for the CB that includes the shaping bits, which may be associated with block code-based constellation shaping (e.g., 850 in FIG. 8) for the encoded shaping bits. In such aspects, jointly decoding the encoded information bits and the encoded shaping bits by the Rx node 704 may include decoding the additional encoded shaping bits. In aspects, the Rx node 704 may be configured to jointly decode the encoded information bits and the encoded shaping bits by decoding a first mapping of at least one parity bit, the encoded shaping bits, and the additional encoded shaping bits from sign bits of the CBG, and decoding a second mapping of at least one information bit from at least one non-sign bit of the CBG, respectively (e.g., decoding the bitwise mapping of each information bit with each corresponding non-sign bit).

At 1406, the Rx node estimates the information bits by encoding the decoded information bits and the decoded shaping bits. As an example, the estimation may be performed, at least in part, by the component 199. FIGS. 7-10 illustrate an example of the Rx node 704 estimating such information bits.

The Rx node 704 may be configured to estimate (at 714) the information bits by encoding the decoded information bits and the decoded shaping bits. For example, the Rx node 704 may reencode the decoded information bits and/or the decoded shaping bits in order to estimate (at 714) the original information bits.

At 1408, it is determined if the Rx node is configured for ACK/NACK responses based on all CBs of a CBG (e.g., as for the configuration 1004 in FIG. 10). If so, the flowchart 1400 continues to 1412. If not, e.g., as for the configuration 1002 in FIG. 10, the flowchart 1400 continues to 1410. As an example, the estimation may be performed, at least in part, by the component 199. FIGS. 7, 10 illustrate an example of the Rx node 704 determining ACK/NACK configurations.

At 1410, the Rx node transmits, for the transmitter node and based on the received CBG, at least one of: a HARQ-ACK for the received CBG that indicates a successful decode for at least one CB of the first set of one or more CBs, the first set of one or more CBs comprising the encoded information bits that are encoded based on the shaping bits, or the unencoded information bits; or a HARQ-NACK for the received CBG, where the HARQ-NACK indicates an unsuccessful decode for at least one CB of the set of one or more CBs. As an example, the transmission may be performed, at least in part, by the component 199. FIGS. 7, 10 illustrate an example of the Rx node 704 transmitting HARQ-ACKs/NACKs to a Tx node (e.g., the Tx node 702).

The Rx node 704 may also notify the Tx node 702 as to whether the CBG 710 (e.g., 802 in FIG. 8; 902, 920 in FIG. 9; 1006, 1008 in FIG. 10) was properly decoded. For instance, the Rx node 704 may be configured to transmit, and the Tx node 702 may be configured to receive, an ACK/NACK 716 that is associated with the decoding of the CBG 710 (e.g., 802 in FIG. 8; 902, 920 in FIG. 9; 1006, 1008 in FIG. 10). In aspects, the ACK/NACK 716 may be a HARQ-ACK or a HARQ-NACK.

In one example, for a first ACK/NACK configuration (e.g., 1002 in FIG. 10), the Rx node 704 may be configured to transmit (e.g., at 1010 in FIG. 10), and the Tx node 702 may be configured to receive, as the ACK/NACK 716, a HARQ-ACK for the CBG 710 (e.g., 802 in FIG. 8; 902, 920 in FIG. 9; 1006, 1008 in FIG. 10) (e.g., that indicates a successful decode for at least one CB of the first set of one or more CBs (e.g., 904-906, 906-908 in FIG. 9), the first set of one or more CBs (e.g., 904-906, 906-908 in FIG. 9) comprising the encoded information bits that are encoded based on the shaping bits, or the unencoded information bits), or a HARQ-NACK for the received CBG (e.g., where the HARQ-NACK indicates an unsuccessful decode for at least one CB of the set of one or more CBs (e.g., 904, 906, 908 in FIG. 9)).

At 1412, the Rx node transmits, for the transmitter node and based on the received CBG, at least one of: a HARQ-ACK for the received CBG, where the HARQ-ACK indicates a successful decode for each CB of the received CBG, or a HARQ-NACK for the received CBG, where the HARQ-NACK that indicates an unsuccessful decode for at least one CB of the received CBG. As an example, the transmission may be performed, at least in part, by the component 199. FIGS. 7, 10 illustrate an example of the Rx node 704 transmitting HARQ-ACKs/NACKs to a Tx node (e.g., the Tx node 702).

The Rx node 704 may also notify the Tx node 702 as to whether the CBG 710 (e.g., 802 in FIG. 8; 902, 920 in FIG. 9; 1006, 1008 in FIG. 10) was properly decoded. For instance, the Rx node 704 may be configured to transmit, and the Tx node 702 may be configured to receive, an ACK/NACK 716 that is associated with the decoding of the CBG 710 (e.g., 802 in FIG. 8; 902, 920 in FIG. 9; 1006, 1008 in FIG. 10). In aspects, the ACK/NACK 716 may be a HARQ-ACK or a HARQ-NACK.

In another example, for a second ACK/NACK configuration (e.g., 1004 in FIG. 10), the Rx node 704 may be configured to transmit (e.g., at 1012 in FIG. 10), and the Tx node 702 may be configured to receive, as the ACK/NACK 716, a HARQ-ACK for the transmitted CBG (e.g., where the HARQ-ACK indicates a successful decode of each CB (e.g., 904, 906, 908 in FIG. 9) of the transmitted CBG), or a HARQ-NACK for the transmitted CBG (e.g., where the HARQ-NACK indicates an unsuccessful decode for at least one CB (e.g., 904, 906, 908 in FIG. 9) of the transmitted CBG).

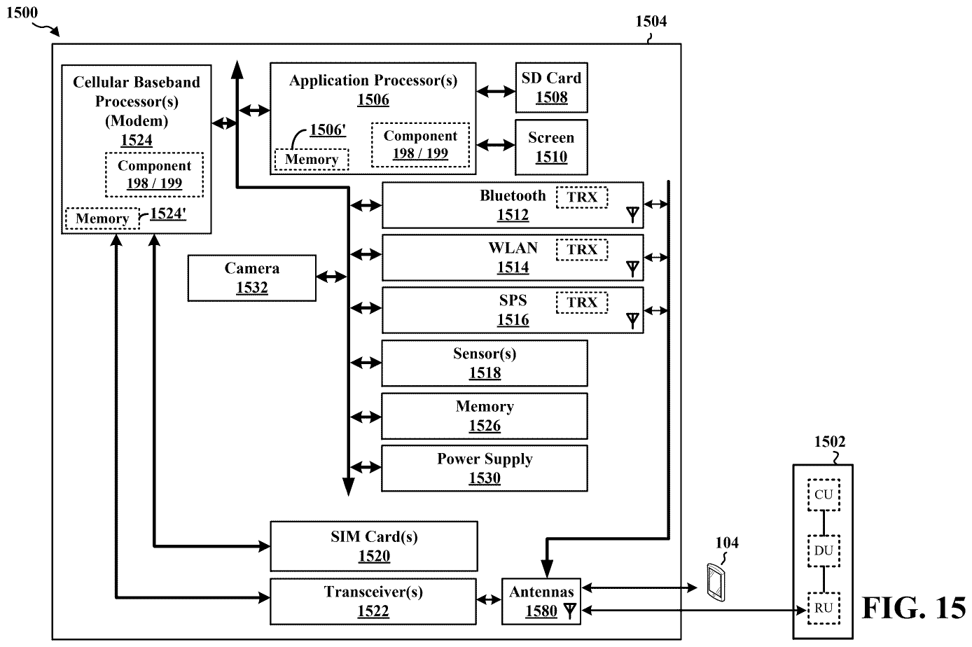

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the component 198 may be configured to generate shaping bits based on information bits for transmission in a CBG, where the CBG is comprised of multiple CBs. The component 198 may be configured to generate encoded shaping bits for at least one of the multiple CBs by encoding the shaping bits using a shaping encoder. The component 198 may be configured to transmit, to a receiver node, the CBG including a first set of one or more CBs comprising encoded information bits that are encoded based on the shaping bits, unencoded information bits, and a second set of one or more CBs including the encoded shaping bits. The component 198 may be configured to generate the encoded information bits for at least another of the multiple CBs by encoding a portion of the information bits for the CBG using the shaping bits. The component 198 may be configured to receive, from the receiver node and based on the transmitted CBG, at least one of: a HARQ-ACK for the transmitted CBG that indicates a successful decode for both of the first set of one or more CBs, the first set of one or more CBs comprising the encoded information bits that are encoded based on the shaping bits, and the unencoded information bits, or a HARQ-NACK for the transmitted CBG that indicates an unsuccessful decode for at least one CB of the first set of one or more CBs, the first set of one or more CBs comprising the encoded information bits that are encoded based on the shaping bits, or the unencoded information bits. The component 198 may be configured to receive, from the receiver node and based on the transmitted CBG, at least one of: a HARQ-ACK for the transmitted CBG, where the HARQ-ACK indicates a successful decode of each CB of the transmitted CBG, or a HARQ-NACK for the transmitted CBG, where the HARQ-NACK indicates an unsuccessful decode for at least one CB of the transmitted CBG. The component 198 may be further configured to perform any of the aspects described in connection with the flowcharts in any of FIGS. 11-14, and/or any of the aspects performed by a sensing node for any of FIGS. 7-10. The component 198 may be within the cellular baseband processor(s) 1524, the application processor(s) 1506, or both the cellular baseband processor(s) 1524 and the application processor(s) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for generating shaping bits based on information bits for transmission in a CBG, where the CBG is comprised of multiple CBs. In the configuration, the apparatus 1504, and in particular the cellular baseband processor(s) 1524 and/or the application processor(s) 1506, may include means for generating encoded shaping bits for at least one of the multiple CBs by encoding the shaping bits using a shaping encoder. In the configuration, the apparatus 1504, and in particular the cellular baseband processor(s) 1524 and/or the application processor(s) 1506, may include means for transmitting, to a receiver node, the CBG including a first set of one or more CBs comprising encoded information bits that are encoded based on the shaping bits, unencoded information bits, and a second set of one or more CBs including the encoded shaping bits. In one configuration, the apparatus 1504, and in particular the cellular baseband processor(s) 1524 and/or the application processor(s) 1506, may include means for generating the encoded information bits for at least another of the multiple CBs by encoding a portion of the information bits for the CBG using the shaping bits. In one configuration, the apparatus 1504, and in particular the cellular baseband processor(s) 1524 and/or the application processor(s) 1506, may include means for receiving, from the receiver node and based on the transmitted CBG, at least one of: a HARQ-ACK for the transmitted CBG that indicates a successful decode for both of the first set of one or more CBs, the first set of one or more CBs comprising the encoded information bits that are encoded based on the shaping bits, and the unencoded information bits, or a HARQ-NACK for the transmitted CBG that indicates an unsuccessful decode for at least one CB of the first set of one or more CBs, the first set of one or more CBs comprising the encoded information bits that are encoded based on the shaping bits, or the unencoded information bits. In one configuration, the apparatus 1504, and in particular the cellular baseband processor(s) 1524 and/or the application processor(s) 1506, may include means for receiving, from the receiver node and based on the transmitted CBG, at least one of: a HARQ-ACK for the transmitted CBG, where the HARQ-ACK indicates a successful decode of each CB of the transmitted CBG, or a HARQ-NACK for the transmitted CBG, where the HARQ-NACK indicates an unsuccessful decode for at least one CB of the transmitted CBG. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

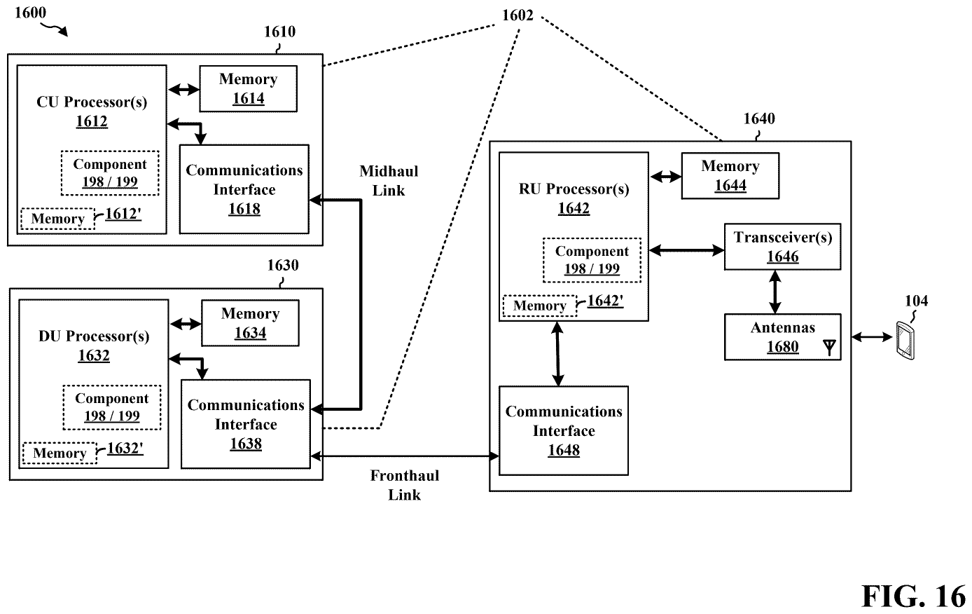

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive a CBG including a set of one or more CBs, the set of one or more CBs comprising unencoded information bits, encoded shaping bits, and encoded information bits that are encoded based on the encoded shaping bits and that represent information bits of a transmitter node. The component 199 may be configured to generate decoded information bits and decoded shaping bits by jointly decoding the encoded information bits and the encoded shaping bits. The component 199 may be configured to estimate the information bits by encoding the decoded information bits and the decoded shaping bits. The component 199 may be configured to transmit, for the transmitter node and based on the received CBG, at least one of: a HARQ-ACK for the received CBG, where the HARQ-ACK indicates a successful decode for both of the set of one or more CBs, or a HARQ-NACK for the received CBG, where the HARQ-NACK indicates an unsuccessful decode for at least one CB of the set of one or more CBs. The component 199 may be configured to transmit, for the transmitter node and based on the received CBG, at least one of: a HARQ-ACK for the received CBG, where the HARQ-ACK indicates a successful decode for each CB of the received CBG, or a HARQ-NACK for the received CBG, where the HARQ-NACK indicates an unsuccessful decode for at least one CB of the received CBG. The component 199 may be further configured to perform any of the aspects described in connection with the flowcharts in any of FIGS. 11-14, and/or any of the aspects performed by a sensing node for any of FIGS. 7-10. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for receiving a CBG including a set of one or more CBs, the set of one or more CBs comprising unencoded information bits, encoded shaping bits, and encoded information bits that are encoded based on the encoded shaping bits and that represent information bits of a transmitter node. In the configuration, the network entity 1602 may include means for generate decoded information bits and decoded shaping bits by jointly decoding the encoded information bits and the encoded shaping bits. In the configuration, the network entity 1602 may include means for estimating the information bits by encoding the decoded information bits and the decoded shaping bits. In one configuration, the network entity 1602 may include means for transmitting, for the transmitter node and based on the received CBG, at least one of: a HARQ-ACK for the received CBG, where the HARQ-ACK indicates a successful decode for both of the set of one or more CBs, or a HARQ-NACK for the received CBG, where the HARQ-NACK indicates an unsuccessful decode for at least one CB of the set of one or more CBs. In one configuration, the network entity 1602 may include means for transmitting, for the transmitter node and based on the received CBG, at least one of: a HARQ-ACK for the received CBG, where the HARQ-ACK indicates a successful decode for each CB of the received CBG, or a HARQ-NACK for the received CBG, where the HARQ-NACK indicates an unsuccessful decode for at least one CB of the received CBG. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

Wireless devices in wireless communication networks may transmit and receive data using CBs. A wireless device may include a Tx that uses a block decoder and a shaping encoder to mask information bits and to jointly encode the shaped information bits and the shaping bits. A Rx of the wireless device may then receive the encoded data, jointly decode the shaped information bits and the shaping bits, and determine the original information bits of the data. This data may be transmitted as TBs, and such TBs may be segmented into CBs. The CBs may be grouped in CBGs to facilitate transmission sizes, retransmissions, and/or the like, for the TBs and data.

Shaping encoders may allow a Tx to generate a mask sequence using LLRs for a block decoder, computed as a power reduction after performing bit masking, and using the shaping bits as the decoder output. In the context of block code-based constellation shaping, an information bit sequence may be divided in subsequences of a given length as inputs to a shaping encoder that uses associated block codes. However, the number of sign bit positions available for such block code-based constellation shaping may be insufficient for the total number of parity bits and shaping bits used. That is, for a given shaping rate of a shaping encoder and a given coding rate for a forward error correction FEC encoder, the total number of parity bits and shaping bits may exceed the number of sign bit positions available. As shaping rate may be a tuning parameter for block-code based shaping, the above may potentially disallow some choices of the shaping rate to be utilized, and consequently the performance of the allowable shaping may be diminished.

Various aspects herein for transmission of shaping bits within a single CBG for block-code based constellation shaping, as well as block code-based constellation shaping within multiple CBGs, may allow a greater range of shaping rates and improve shaping performance by transmitting shaping bits for a CBG in one or more specific CBs within the CBG from which the shaping bits are generated, may improve Rx latency and Tx encoding efficiency/performance by transmitting a shaping bit-specific CB at the beginning of the CBG or at the end of the CBG, and may improve encoding block performance by applying block-code based constellation shaping to the shaping bit-specific CB that carries the shaping bits of the CBG.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a transmitter node, comprising: generating shaping bits based on information bits for transmission in a code block group (CBG), wherein the CBG is comprised of multiple code blocks (CBs); generating encoded shaping bits for at least one of the multiple CBs by encoding the shaping bits using a shaping encoder; and transmitting, to a receiver node, the CBG including a first set of one or more CBs comprising encoded information bits that are encoded based on the shaping bits, unencoded information bits, and a second set of one or more CBs including the encoded shaping bits.

Aspect 2 is the method of aspect 1, wherein the shaping encoder is configured to encode using block code-based constellation shaping, wherein the shaping bits are configured to alter a distribution, by masking the information bits, of at least one symbol in the CBG for the block code-based constellation shaping.

Aspect 3 is the method of any of aspects 1 and 2, wherein the at least one of the multiple CBs that includes the encoded shaping bits includes a first CB of the multiple CBs that is transmitted or includes a final CB of the multiple CBs that is transmitted.

Aspect 4 is the method of aspect 3, further comprising: generating the encoded information bits for at least another of the multiple CBs by encoding a portion of the information bits for the CBG using the shaping bits.

Aspect 5 is the method of aspect 4, wherein at least one of encoding the shaping bits or encoding the portion of the information bits for the CBG using the shaping bits includes encoding based on at least one forward error correction (FEC) encoder.

Aspect 6 is the method of any of aspects 1 and 3 to 5, wherein encoding the shaping bits includes encoding the shaping bits in an absence of block code-based constellation shaping for the at least one of the multiple CBs.

Aspect 7 is the method of any of aspects 1 to 5, wherein encoding the shaping bits includes: generating additional shaping bits based on the shaping bits; and encoding the shaping bits and the additional shaping bits using block code-based constellation shaping.

Aspect 8 is the method of aspect 7, wherein encoding the shaping bits includes: generating at least one parity bit for the CBG based on encoding the shaping bits; mapping the at least one parity bit, the shaping bits, and the additional shaping bits to sign bits of the CBG; and mapping at least one information bit of the at least one of the multiple CBs to at least one non-sign bit of the CBG, respectively.

Aspect 9 is the method of any of aspects 1 to 8, further comprising: receiving, from the receiver node and based on the transmitted CBG, at least one of: a hybrid automatic repeat request (HARQ) acknowledgement (HARQ-ACK) for the transmitted CBG that indicates a successful decode for both of the first set of one or more CBs, the first set of one or more CBs comprising the encoded information bits that are encoded based on the shaping bits, and the unencoded information bits; or a HARQ negative acknowledgement (HARQ-NACK) for the transmitted CBG that indicates an unsuccessful decode for at least one CB of the first set of one or more CBs, the first set of one or more CBs comprising the encoded information bits that are encoded based on the shaping bits, or the unencoded information bits.

Aspect 10 is the method of any of aspects 1 to 8, further comprising: receiving, from the receiver node and based on the transmitted CBG, at least one of: a hybrid automatic repeat request (HARQ) acknowledgement (HARQ-ACK) for the transmitted CBG, wherein the HARQ-ACK indicates a successful decode of each CB of the transmitted CBG; or a HARQ negative acknowledgement (HARQ-NACK) for the transmitted CBG, wherein the HARQ-NACK indicates an unsuccessful decode for at least one CB of the transmitted CBG.

Aspect 11 is a method of wireless communication at a receiver node, comprising: receiving a code block group (CBG) including a set of one or more code blocks (CBs), the set of one or more CBs comprising unencoded information bits, encoded shaping bits, and encoded information bits that are encoded based on the encoded shaping bits and that represent information bits of a transmitter node; generating decoded information bits and decoded shaping bits by jointly decoding the encoded information bits and the encoded shaping bits; and estimating the information bits by encoding the decoded information bits and the decoded shaping bits.

Aspect 12 is the method of aspect 11, wherein the encoded shaping bits and the encoded information bits are based on an encoding using block code-based constellation shaping, wherein the encoded shaping bits are configured to alter a distribution, using masking on the information bits, of at least one symbol in the CBG for the block code-based constellation shaping.

Aspect 13 is the method of any of aspects 11 and 12, wherein the set of one or more CBs that includes the encoded shaping bits includes a first CB of the set of one or more CBs that is transmitted or includes a final CB of the set of one or more CBs that is transmitted.

Aspect 14 is the method of aspect 13, wherein jointly decoding the encoded information bits and the encoded shaping bits for the CBG includes decoding at least one forward error correction (FEC) encoding.

Aspect 15 is the method of any of aspects 11 and 13 to 14, wherein the encoded shaping bits do not include block code-based constellation shaping for the encoded shaping bits.

Aspect 16 is the method of any of aspects 11 to 14, wherein the encoded shaping bits include additional encoded shaping bits associated with block code-based constellation shaping for the encoded shaping bits; and wherein jointly decoding the encoded information bits and the encoded shaping bits includes: decoding the additional encoded shaping bits.

Aspect 17 is the method of aspect 16, wherein jointly decoding the encoded information bits and the encoded shaping bits includes: decoding a first mapping of at least one parity bit, the encoded shaping bits, and the additional encoded shaping bits from sign bits of the CBG; and decoding a second mapping of at least one information bit from at least one non-sign bit of the CBG, respectively.

Aspect 18 is the method of any of aspects 11 to 17, further comprising: transmitting, for the transmitter node and based on the received CBG, at least one of: a hybrid automatic repeat request (HARQ) acknowledgement (HARQ-ACK) for the received CBG that indicates a successful decode for at least one CB of the first set of one or more CBs, the first set of one or more CBs comprising the encoded information bits that are encoded based on the shaping bits, or the unencoded information bits; or a HARQ negative acknowledgement (HARQ-NACK) for the received CBG, wherein the HARQ-NACK indicates an unsuccessful decode for at least one CB of the set of one or more CBs.

Aspect 19 is the method of any of aspects 11 to 17, further comprising: transmitting, for the transmitter node and based on the received CBG, at least one of: a hybrid automatic repeat request (HARQ) acknowledgement (HARQ-ACK) for the received CBG, wherein the HARQ-ACK indicates a successful decode for each CB of the received CBG; or a HARQ negative acknowledgement (HARQ-NACK) for the received CBG, wherein the HARQ-NACK indicates an unsuccessful decode for at least one CB of the received CBG.

Aspect 20 is an apparatus for wireless communication including means for implementing any of aspects 1 to 10.

Aspect 21 is a computer-readable medium (e.g., a non-transitory computer-readable medium) storing computer executable code, the code when executed by at least one processor causes the at least one processor to implement any of aspects 1 to 10.

Aspect 22 is an apparatus for wireless communication at a transmitter node. The apparatus includes at least one memory; and at least one processor coupled to the memory and, based at least in part on information stored in the at least one memory, the at least one processor is configured to implement any of aspects 1 to 10.

Aspect 23 is the apparatus of aspect 22, further including at least one of a transceiver or an antenna coupled to the at least one processor.

Aspect 24 is an apparatus for wireless communication including means for implementing any of aspects 11 to 19.

Aspect 25 is a computer-readable medium (e.g., a non-transitory computer-readable medium) storing computer executable code, the code when executed by at least one processor causes the at least one processor to implement any of aspects 11 to 19.

Aspect 26 is an apparatus for wireless communication at a receiver node. The apparatus includes at least one memory; and at least one processor coupled to the memory and, based at least in part on information stored in the at least one memory, the at least one processor is configured to implement any of aspects 11 to 19.

Aspect 27 is the apparatus of aspect 26, further including at least one of a transceiver or an antenna coupled to the at least one processor.

Aspect 28 is an apparatus for wireless communication at a transmitter node. The apparatus includes at least one memory and at least one processor coupled to the at least one memory. The at least one processor, individually or in any combination, is configured to cause the apparatus to implement any of aspects 1 to 10.

Aspect 29 is an apparatus for wireless communication at a receiver node. The apparatus includes at least one memory and at least one processor coupled to the at least one memory. The at least one processor, individually or in any combination, is configured to cause the apparatus to implement any of aspects 11 to 19.

1. An apparatus for wireless communication at a transmitter node, comprising:
at least one memory; and
at least one processor coupled to the at least one memory and, based at least in part on information stored in the at least one memory, the at least one processor, individually or in any combination, is configured to cause the apparatus to:
generate shaping bits based on information bits for transmission in a code block group (CBG), wherein the CBG is comprised of multiple code blocks (CBs);
generate encoded shaping bits for at least one of the multiple CBs by encoding the shaping bits using a shaping encoder; and
transmit, to a receiver node, the CBG including a first set of one or more CBs comprising encoded information bits that are encoded based on the shaping bits, unencoded information bits, and a second set of one or more CBs including the encoded shaping bits.

2. The apparatus of claim 1, wherein the shaping encoder is configured to encode using block code-based constellation shaping, wherein the shaping bits are configured to alter a distribution, by masking the information bits, of at least one symbol in the CBG for the block code-based constellation shaping.

3. The apparatus of claim 1, wherein the at least one of the multiple CBs that includes the encoded shaping bits includes a first CB of the multiple CBs that is transmitted or includes a final CB of the multiple CBs that is transmitted.

4. The apparatus of claim 3, wherein the at least one processor, individually or in any combination, is further configured to cause the apparatus to:
generate the encoded information bits for at least another of the multiple CBs by encoding a portion of the information bits for the CBG using the shaping bits.

5. The apparatus of claim 4, wherein for at least one of to encode the shaping bits or to encode the portion of the information bits for the CBG using the shaping bits, the at least one processor, individually or in any combination, is configured to cause the apparatus to encode based on at least one forward error correction (FEC) encoder.

6. The apparatus of claim 1, wherein to encode the shaping bits, the at least one processor, individually or in any combination, is configured to cause the apparatus to encode the shaping bits in an absence of block code-based constellation shaping for the at least one of the multiple CBs.

7. The apparatus of claim 1, wherein to encode the shaping bits, the at least one processor, individually or in any combination, is configured to cause the apparatus to:
generate additional shaping bits based on the shaping bits; and
encode the shaping bits and the additional shaping bits using block code-based constellation shaping.

8. The apparatus of claim 7, wherein to encode the shaping bits, the at least one processor, individually or in any combination, is configured to cause the apparatus to:
generate at least one parity bit for the CBG based on encoding the shaping bits;
map the at least one parity bit, the shaping bits, and the additional shaping bits to sign bits of the CBG; and
map at least one information bit of the at least one of the multiple CBs to at least one non-sign bit of the CBG, respectively.

9. The apparatus of claim 1, wherein the at least one processor, individually or in any combination, is further configured to cause the apparatus to:
receive, from the receiver node and based on the transmitted CBG, at least one of:
a hybrid automatic repeat request (HARQ) acknowledgement (HARQ-ACK) for the transmitted CBG that indicates a successful decode for both of the first set of one or more CBs, the first set of one or more CBs comprising the encoded information bits that are encoded based on the shaping bits, and the unencoded information bits; or
a HARQ negative acknowledgement (HARQ-NACK) for the transmitted CBG that indicates an unsuccessful decode for at least one CB of the first set of one or more CBs, the first set of one or more CBs comprising the encoded information bits that are encoded based on the shaping bits, or the unencoded information bits.

10. The apparatus of claim 1, wherein the at least one processor, individually or in any combination, is further configured to cause the apparatus to:
receive, from the receiver node and based on the transmitted CBG, at least one of:
a hybrid automatic repeat request (HARQ) acknowledgement (HARQ-ACK) for the transmitted CBG, wherein the HARQ-ACK indicates a successful decode of each CB of the transmitted CBG; or
a HARQ negative acknowledgement (HARQ-NACK) for the transmitted CBG, wherein the HARQ-NACK indicates an unsuccessful decode for at least one CB of the transmitted CBG.

11. An apparatus for wireless communication at a receiver node, comprising:
at least one memory; and
at least one processor coupled to the at least one memory and, based at least in part on information stored in the at least one memory, the at least one processor, individually or in any combination, is configured to cause the apparatus to:
receive a code block group (CBG) including a set of one or more code blocks (CBs), the set of one or more CBs comprising unencoded information bits, encoded shaping bits, and encoded information bits that are encoded based on the encoded shaping bits and that represent information bits of a transmitter node;
generate decoded information bits and decoded shaping bits by jointly decoding the encoded information bits and the encoded shaping bits; and
estimate the information bits by encoding the decoded information bits and the decoded shaping bits.

12. The apparatus of claim 11, wherein the encoded shaping bits and the encoded information bits are based on an encoding using block code-based constellation shaping, wherein the encoded shaping bits are configured to alter a distribution, using masking on the information bits, of at least one symbol in the CBG for the block code-based constellation shaping.

13. The apparatus of claim 11, wherein the set of one or more CBs that includes the encoded shaping bits includes a first CB of the set of one or more CBs that is transmitted or includes a final CB of the set of one or more CBs that is transmitted.

14. The apparatus of claim 13, wherein to jointly decode the encoded information bits and the encoded shaping bits for the CBG, the at least one processor, individually or in any combination, is configured to cause the apparatus to decode at least one forward error correction (FEC) encoding.

15. The apparatus of claim 11, wherein the encoded shaping bits do not include block code-based constellation shaping for the encoded shaping bits.

16. The apparatus of claim 11, wherein the encoded shaping bits include additional encoded shaping bits associated with block code-based constellation shaping for the encoded shaping bits; and
wherein to jointly decode the encoded information bits and the encoded shaping bits, the at least one processor, individually or in any combination, is configured to cause the apparatus to:
decode the additional encoded shaping bits.

17. The apparatus of claim 16, wherein to jointly decode the encoded information bits and the encoded shaping bits, the at least one processor, individually or in any combination, is configured to cause the apparatus to:
decode a first mapping of at least one parity bit, the encoded shaping bits, and the additional encoded shaping bits from sign bits of the CBG; and
decode a second mapping of at least one information bit from at least one non-sign bit of the CBG, respectively.

18. The apparatus of claim 11, wherein the at least one processor, individually or in any combination, is further configured to cause the apparatus to:
transmit, for the transmitter node and based on the received CBG, at least one of:
a hybrid automatic repeat request (HARQ) acknowledgement (HARQ-ACK) for the received CBG that indicates a successful decode for at least one CB of a first set of one or more CBs, the first set of one or more CBs comprising the encoded information bits that are encoded based on the shaping bits, or the unencoded information bits; or
a HARQ negative acknowledgement (HARQ-NACK) for the received CBG, wherein the HARQ-NACK indicates an unsuccessful decode for the at least one CB of the set of one or more CBs.

19. The apparatus of claim 11, wherein the at least one processor, individually or in any combination, is further configured to cause the apparatus to:
transmit, for the transmitter node and based on the received CBG, at least one of:
a hybrid automatic repeat request (HARQ) acknowledgement (HARQ-ACK) for the received CBG, wherein the HARQ-ACK indicates a successful decode for each CB of the received CBG; or
a HARQ negative acknowledgement (HARQ-NACK) for the received CBG, wherein the HARQ-NACK indicates an unsuccessful decode for at least one CB of the received CBG.

20. A method of wireless communication at a transmitter node, comprising:
generating shaping bits based on information bits for transmission in a code block group (CBG), wherein the CBG is comprised of multiple code blocks (CBs);
generating encoded shaping bits for at least one of the multiple CBs by encoding the shaping bits using a shaping encoder; and
transmitting, to a receiver node, the CBG including a first set of one or more CBs comprising encoded information bits that are encoded based on the shaping bits, unencoded information bits, and a second set of one or more CBs including the encoded shaping bits.

21-30. (canceled)
